(19) United States
(12) Patent Application Publication
(10) Pub. No.: US 2026/0241571 A1
(43) Pub. Date: Aug. 20, 2026

(54) SYSTEMS AND METHODS FOR HANDLING TRACK MATERIALS

(71) Applicant: B & B Metals, Inc., Shepherdsville, KY (US)

(72) Inventor: Coty T. Coots, Shepherdsville, KY (US)

(21) Appl. No.: 19/543,276

(22) Filed: Feb. 18, 2026

Related U.S. Application Data
(60) Provisional application No. 63/760,259, filed on Feb. 19, 2025.

(51) Int. Cl. B25J 9/16; B25J 5/00; B25J 19/02; B65G 61/00; E01B 29/32; E01B 35/06

(52) U.S. Cl. CPC B25J 9/1687; B25J 9/163; B25J 9/1697; B25J 19/02; B65G 61/00; E01B 29/32; E01B 35/06; B25J 5/007

(57) ABSTRACT

A system and method of handling track materials includes identifying, using a vision sensor, a track material having a character, determining, using a trained neural network, whether the character of the track material, for a rail assembly operation, satisfies an operation threshold, and in response to determining whether the character satisfies the operation threshold, placing, using a robotic arm, the track material at a target location.

### TECHNICAL FIELD

The present disclosure relates to railroad infrastructure maintenance, and more particularly, but without limitation, to railroad track maintenance involving track material handling and collection.

### BACKGROUND

Railroad tracks need to be regularly maintained to ensure optimal performance. This maintenance may require temporary shutdowns, which can affect train operations. Unfortunately, manually handling and distribution of track materials is both laborious and time-consuming.

### SUMMARY

The present application discloses one or more of the features recited in the appended claims and/or the following features which alone or in any combination, may comprise patentable subject matter.

In one aspect, a method of handling track materials includes identifying, using a vision sensor, a track material having a character, determining, using a trained neural network, whether the character of the track material, for a rail assembly operation, satisfies an operation threshold, and in response to determining whether the character satisfies the operation threshold, placing, using a robotic arm, the track material at a target location.

In a second aspect, a system for handling track materials includes a robotic arm operable to manipulate a track material at a location, a vision sensor associated with the robotic arm, and a controller comprising a trained neural network. The vision sensor is configured to identify a character of the track material. The trained neural network is configured to determine whether the character of the track material, for a rail assembly operation, satisfies an operation threshold. The robotic arm is configured to place the track material at a target location.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. All of the above outlined features are to be understood as exemplary only and many more features and objectives of the various aspects may be gleaned from the disclosure herein. Therefore, no limiting interpretation of this summary is to be understood without further reading of the entire specification, claims, and drawings, included herewith. A more extensive presentation of features, details, utilities, and advantages of the present disclosure is provided in the following written description of various aspects of the disclosure, illustrated in the accompanying drawings, and defined in the appended claims.

### BRIEF DESCRIPTION OF THE DRAWINGS

The aspects set forth in the drawings are illustrative and exemplary in nature and not intended to limit the subject matter defined by the claims. The following detailed description of the illustrative aspects can be understood when read in conjunction with the following drawings, where like structure is indicated with like reference numerals and in which:

FIG. 1 schematically depicts an example track material handling system of the present disclosure, according to one or more aspects shown and described herein;

FIG. 2 schematically depicts non-limiting components of the devices on the track material handling system of the present disclosure, according to one or more aspects shown and described herein;

FIG. 3A schematically depicts an example robotic arm of the track material handling system including an impactive end effector of the present disclosure, according to one or more aspects shown and described herein;

FIG. 3B schematically depicts an example robotic arm of the track material handling system including an astrictive end effector of the present disclosure, according to one or more aspects shown and described herein;

FIG. 4A schematically depicts an example track material handling system handling a non-limiting tie plate of the present disclosure, according to one or more aspects shown and described herein;

FIG. 4B schematically depicts an example track material handling system handling a non-limiting spike of the present disclosure, according to one or more aspects shown and described herein;

FIG. 4C schematically depicts an example track material handling system handling a non-limiting anchor of the present disclosure, according to one or more aspects shown and described herein;

FIG. 4D schematically depicts an example track material handling system handling a non-limiting clip of the present disclosure, according to one or more aspects shown and described herein;

FIG. 4E schematically depicts an example track material handling system handling a non-limiting screw of the present disclosure, according to one or more aspects shown and described herein;

FIG. 4F schematically depicts an example track material handling system handling a non-limiting pad of the present disclosure, according to one or more aspects shown and described herein;

FIG. 4G schematically depicts an example track material handling system handling a non-limiting crosstie of the present disclosure, according to one or more aspects shown and described herein;

FIG. 5A schematically depicts an example track material handling system moving on a railway of the present disclosure, according to one or more aspects shown and described herein;

FIG. 5B schematically depicts an example track material handling system moving off the railway of the present disclosure, according to one or more aspects shown and described herein;

FIG. 6 schematically depicts a track material handling system lifting and/or placing tie plates during the track material handling of the present disclosure, according to one or more aspects shown and described herein;

FIG. 7A schematically depicts an example of a track material flipping using the track material handling system of the present disclosure, according to one or more aspects shown and described herein;

FIG. 7B schematically depicts an example of a track material distribution using the track material handling system of the present disclosure, according to one or more aspects shown and described herein;

FIG. 8A schematically depicts an example of a track material handling during track material inspection using the current disclosed track material handling system of the present disclosure, according to one or more aspects shown and described herein;

FIG. 8B schematically depicts an example of a track material handling during track material replacement using the track material handling system of the present disclosure, according to one or more aspects shown and described herein;

FIG. 9 schematically depicts a track material handling system having a containment bed and a conveyor of the present disclosure, according to one or more aspects shown and described herein;

FIG. 10 schematically illustrates a flow diagram of illustrative steps for track material handling of the present disclosure, according to one or more aspects shown and described herein; and

FIG. 11 schematically illustrates a flow diagram of illustrative steps for neural network training of the present disclosure, according to one or more aspects shown and described herein.

### DETAILED DESCRIPTION

Track materials, such as tie plates, spikes, anchors, clips, screws, concrete sleeper pads, or crossties, serve important roles in maintaining railway infrastructure. Each track material has specific characteristics, classifications, and quality evaluation criteria to ensure functionality and durability. The handling of these track materials often involves complicated systems. The track materials are often found in varied or unexpected locations along the railroad track, complicating their handling and manipulation. Additionally, the track materials can differ in quality and/or conditions, with some being suitable for reuse while others may need to be replaced or discarded. The quality of each track material affects how it is desirably handled: track materials in good condition can be reused, while those deemed substandard can be removed and placed in a reject bin. These varying conditions require different handling methods and placement in specific locations, often necessitating the use of specialized equipment to manage each material accordingly.

Furthermore, the evaluation of quality of a track material has a subjective element, and can often be based on an evaluation of the overall condition of the track material, inspecting damage or wear, or the like. These determinations may be difficult to implement with traditional “decision tree” algorithms where each input follows a predetermined path to reach a conclusion. For example, a rigid decision tree algorithm may fail to capture the nuanced interplay between multiple factors that could indicate wear, like how a slightly rough surface combined with minor discoloration might suggest wear even if neither factor alone crosses a threshold.

To address these challenges, the present disclosure introduces a track material handling system that integrates a robotic arm equipped with a vision system. In some aspects of the current disclosure, the track material handling system includes a vision sensor, a robotic arm, and a controller. This track material handling system automates the detection, classification, and handling of track materials based on their condition. It can perform tasks such as sorting, redistributing, and preparing materials for installation or removal, ensuring that each material is managed according to its intended use. The system incorporates sensors and imaging technology that evaluate materials and determine their appropriate handling, whether for reuse, rejection, or redistribution. For example, the track material handling system may detect one or more track materials along the railroad track or/and ties. The system may use the robotic arm to handle the track materials in various positions, such as an assembled position, a distribution position, or a reinstallation position. The track material handling system may also distribute the track materials, using the robotic arm, at a target location, such as the rail, the tie, a container associated with the robotic arm, or a conveyor. The system can integrate sensors and imaging technology to detect flaws, segregate substandard parts, and reduce manual inspection efforts.

The track material handling system thus reduces the need for manual decision-making and manipulation of track materials by automating the detection, evaluation, and handling of track materials. This results in a more efficient workflow and allows for consistent material management across different track environments. For example, the robotic arm allows for the manipulation of materials as they are found, making it desirable for deployment in diverse environments. The vision system enables both the placement and the identification of condition of track materials, allowing the controller to make decisions based on this information. This automation reduces the need for human intervention, enhancing efficiency and consistency in the application of standards, particularly where a subjective determination is involved as described above. As a result, the system supports more reliable and streamlined maintenance operations, minimizing errors and improving overall operational effectiveness.

Further, the track material handling system may include localized artificial intelligence (AI) implementation. The AI integration can eliminate the need for or reduce reliance on a manual control system or continuous cellular link, simplifying the deployment process and reducing infrastructure costs. This approach enhances operational efficiency by enabling autonomous decision-making on-site, without relying on constant remote communication. As a result, the system is easier to implement, more reliable, and better suited for on-the-ground railway maintenance, while also minimizing potential downtime and ensuring more consistent application of standards.

The AI implementation may include application of neural networks for evaluating the quality of track materials. Unlike traditional decision tree algorithms, which require explicit, predetermined paths to reach a conclusion, neural networks excel at identifying complex, non-linear patterns in data. The neural networks can capture subtle relationships, such as how the combination of slight roughness and minor discoloration might indicate wear, even when these individual factors fall below defined thresholds. For example, the disclosed neural networks can learn subjective evaluation patterns from expert-labeled data, by training a model on a dataset containing images of track materials and corresponding quality assessments from experienced inspectors. Moreover, the disclosed neural networks can adapt over time, allowing for continuous improvement as more data becomes available, thereby eliminating the need to manually adjust decision thresholds or update rules, as would be required with decision trees or other static models.

Various aspects of the systems and methods for track material handling are described in more detail herein. Whenever possible, the same reference numerals will be used throughout the drawings to refer to the same or like parts.

As used herein, the singular forms “a,” “an” and “the” include plural referents unless the context clearly dictates otherwise. Thus, for example, reference to “a” component includes aspects having two or more such components unless the context clearly indicates otherwise.

Throughout the disclosure, “railroad” refers to a transportation infrastructure including a network of tracks made from metal or non-metal rails upon which trains or other vehicles operate. The “rails” refer to one or more parallel metal or non-metal rails that provide a pathway for trains or other vehicles to move along. The rails may be laid on a trackbed, such as track ballast, to hold the railroad track in place as the trains roll over it, to bear the compression load of the rails and ties, to facilitate drainage, and to keep down vegetation that can compromise the integrity of the combined track structure. The track ballast may include crushed stone, washed gravel, bank run gravel, torpedo gravel, slag, chats, coal cinders, sand, or burnt clay.

Throughout the disclosure, “ties” refer to supports, for example, wooden supports, laid perpendicular or non-perpendicular to the rails. The ties hold the rails in place and distribute the weight of the vehicles moving on the rails to the railroad track bed. The disclosed ties may include, but are not limited to, stone block ties, wooden ties, concrete ties, steel ties, or plastic ties.

Throughout the disclosure, “track materials” refer to components used in the construction and maintenance of railway tracks. The track materials may include, without limitation, a tie plate, a spike, an anchor, a clip, a screw, a crosstie, a pad, a bolt, a nut, a joint, a switch, a rail, or other components designed to support the load of trains and guide the trains along a desired path.

Throughout the disclosure, an “empty tie” refers to a railroad tie that lacks one or more track materials that are to be distributed on or in proximity to the railroad tie based on a maintenance sequence, such as, without limitation, railroad inspection, railroad replacement, or track materials upgrades. In one aspect, when the maintenance sequence includes distributing track materials to any tie that lacks a track material, an empty tie may be a tie that lacks a distributed track material positioned between the tie and the rail and has no distributed track material placed on or in proximity to the tie.

Throughout the disclosure, “tie plates” refer to metal or non-metal plates that are placed between the bottom of the rails and the top of the ties, which provide a larger surface area for the rails to rest on and distribute the impact loads from the rails to the tie. The tie plate may be a rectangular component with a wedge-shaped thickness profile, for example, up to two shoulders to hold the rail base. The tie plates may include a selection of single-shoulder tie plates, double-shoulder tie plates, hook twin tie plates, or a combination thereof. A “single-shoulder tie plate” refers to a tie plate with a single shoulder on the top surface of the tie plate, which is usually placed on the outside of a rail. A “double-shoulder tie plate” refers to a tie plate having two shoulders on the top surface. A “hook twin tie plate” refers to a tie plate including a slotted hole, which works in pairs with a single tie to ensure tie spacing. The hook twin tie plate may be used for specific railway components, such as, without limitation, a frog, a guide rail, or a rail switch.

Throughout the disclosure, “spikes” refer to a type of fastener used to secure rails to the ties beneath the rails. The spikes may be nail-shaped fasteners with overhanging heads used to secure rail components, such as the tie plates, to wooden crossties and keep rails in place. The spikes may include a pointed end for driving into the tie and a flat or angled head that holds the rail firmly in place. The spikes may be nail-shaped, featuring a head that overhangs the shank. The spikes may fasten the tie plate to the tie, with the overhanging head of the spikes also overlapping the rail, fixturing the rail and tie plate to the tie. The spikes may be, without limitation, a cut spike, a dog spike, or other types of spikes used in the rail system.

Throughout the disclosure, “anchors” refer to a type of fastener used to reduce shifts in angular alignment between rail and crosstie. The anchors may include spring-loaded clamps attached to the base of the rail on either side of the wooden crosstie. The spring-loaded clamps may attach to the rail base on either side of the tie, preventing angular misalignment between the rail and the tie. In some aspects, anchors may attach to the underside of the rail baseplate and bear against the sides of the ties to prevent longitudinal movement of the rail, either from changes in temperature or through vibration.

Throughout the disclosure, “clips” refer to a type of fastener used to securely attach the rails to the ties. Clips may be spring-loaded fasteners that secure the rail to the tie plate or the tie, with some held in place by spring friction and others secured by screws. In some aspects, the clips may fasten the rail to the tie plate when wooden crossties are used. In some aspects, the clips may fasten the rail directly to the concrete tie (e.g., sleeper). In some aspects, the clip may hold in place due to spring friction. Other cases use screw fasteners to hold the clip in place. The clips may be, without limitation, a Pandrol® clip, an SKL clip, an E-clip, a fast clip, a bolted clip, or other types of clips used in the rail system.

Throughout the disclosure, “screws” refer to a type of fastening component used to secure ties or to attach base plates or rail fastenings to the ties. The screws provide assistance in holding the rail in position relative to the crosstie or sleeper. In operation, the screws may be screwed into a hole bored in the tie.

Throughout the disclosure, “crossties” refer to a horizontal structural component in railway tracks. The crossties lie beneath and perpendicular to the rails, providing support and fixing a location of other railway materials (such that a track gauge is maintained across the crossties). The crosstie may include wooden crossties, concrete sleepers, steel sleepers, composite sleepers, or other types of ties to support the rails. In assembly, the crossties distribute the weight of the locomotive to the ground to maintain the railway track positioning, direction, and grade.

Throughout the disclosure, “pads” refer to buffering components between specific track components to provide cushioning, reduce wear, and extend the lifespan of the track components. The pads may be wear plate impact-absorbing buffers located between the rail and ties (e.g., concrete sleeper). The pads may include a rubber or plastic compound. The pads may handle shifting loads maintaining a barrier between the rail and tie.

Throughout the disclosure, a “robotic arm” refers to a sequential arrangement of interconnected links that undergo motion facilitated by joints. The robotic arm may be actuated by motors or human manipulation. The interconnected links connected by joints may allow either rotational motion or translational (e.g., linear) displacement. Throughout the disclosure, the “moveable arm” may interchangeably refer to “robotic arm.”

Throughout the disclosure, a vehicle may include, without limitation, a locomotive, a railcar, a rail truck, maintenance-of-way equipment, a road-rail vehicle, or any vehicle designed to move on or adjacent to the rails. The disclosed vehicle may be a self-propelled vehicle and include an engine or motor to propel the vehicle along the railroad track and/or for on-road usage. The disclosed vehicle may include, without limitation, wheels (e.g., flange wheels adept at navigating the track contours), axles, braking systems (e.g., hydraulic brakes, electric brakes, air brakes), propulsion mechanisms (e.g., electric motors or diesel-electric engines), communication systems, or illumination systems (e.g., headlights, taillights, or marker lights). Particularly, a “road-rail vehicle” refers to a vehicle equipped with both rail wheels and road wheels, allowing the vehicle to travel on both railway tracks and regular roads. The motion mechanism may include, without limitation, a selection of rubber wheels, rail wheels, flanged wheels, metal wheels, continuous tracks, or a combination thereof. The continuous tracks may be, without limitation, metal link tracks, rubber tracks, single-pin tracks, or double-pin tracks.

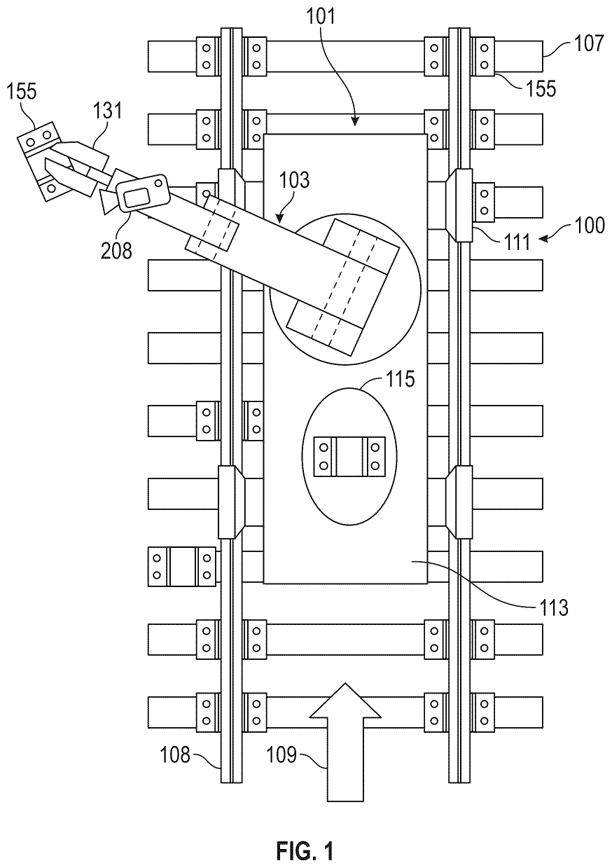

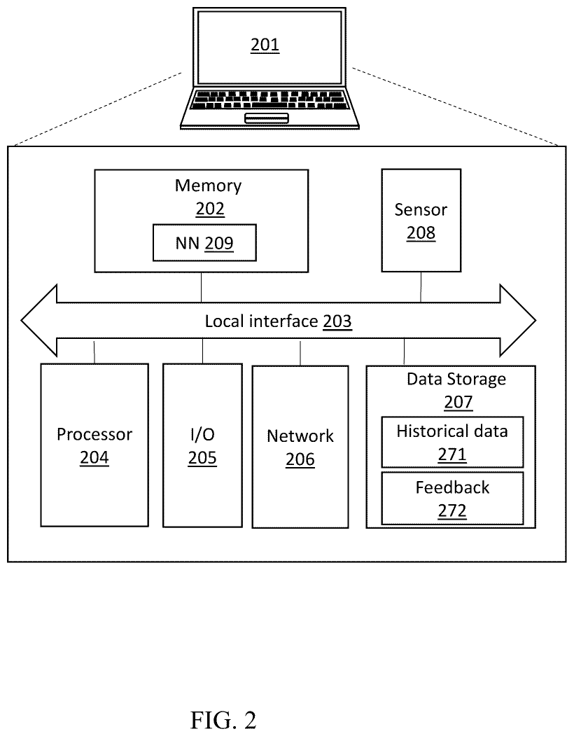

Turning to the figures, FIGS. 1 and 2 schematically depict a track material handling system 100. The track material handling system 100 includes a robotic arm 103 and a vision sensor 208. The vision sensor 208 may be positioned on the robotic arm 103 or a component or device that is remote (e.g., separate) from the robotic arm 103.

In some aspects, the track material handling system 100 may include or be implemented at a vehicle 101. The vehicle 101 includes one or more motion mechanisms 111 and a chassis 113. A target location 115 is illustrated, and described in more detail elsewhere herein. The robotic arm 103 may be mechanically coupled to the vehicle 101. For example, in some aspects, the robotic arm 103 may be positioned on and/or affixed to the chassis 113 of the vehicle 101. In some aspects, the track material handling system 100 may be situated at a position along a path 109. The path 109 may be along a railroad track. In some examples, track material 155 may be present at the position and the track material 155 may be within the reach of the robotic arm 103. The robotic arm 103 may have a plurality of degrees of freedom and have a retaining mechanism 131 at an end of the robotic arm 103. The robotic arm 103 may be operable to handle the track material 155 via the retaining mechanism 131. The robotic arm 103 and/or the vehicle 101 may move along a railroad track including one or more rails 108 and one or more ties 107.

The track material handling system 100 may include or be associated with a controller 201 (illustrated in FIG. 2). In some aspects, the track material handling system 100 may include multiple controllers 201, such as a first controller 201 and a second controller 201. Any operation by a controller 201 described herein can be performed by multiple controllers 201, such as a first operation by a first controller 201 and a second operation by a second controller 201.

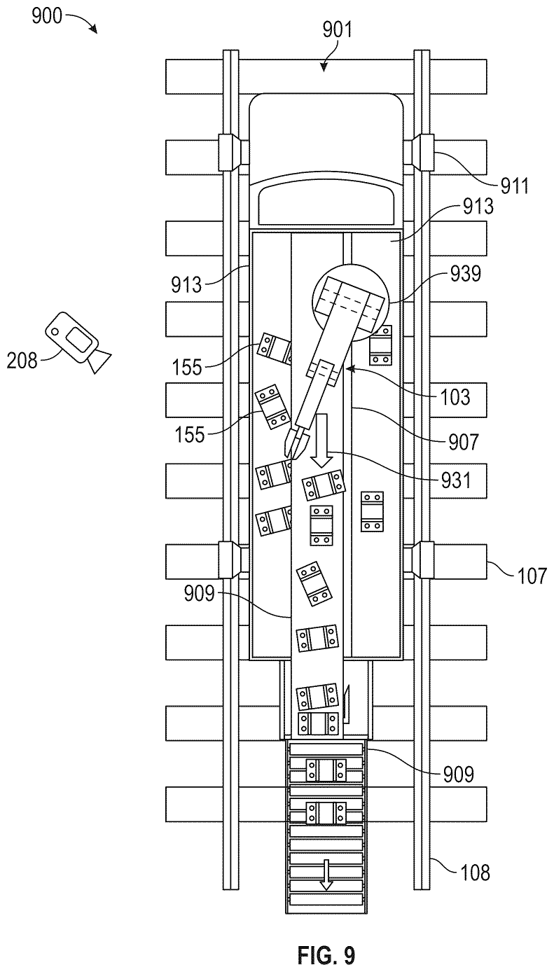

FIG. 2 is a diagram illustrating an example architecture of a controller 201. The controller 201 may include various components, such as a memory component 202 (illustrated as “memory 202”), one or more processors 204 (illustrated and referred to hereinafter as “processor 204”), an input/output interface 205, a network interface 206, a data storage component 207, and a local interface 203. The controller 201 may include or be in communication with a vision sensor 208. The controller 201 may include one or more modules, such as a vehicle control module to operate the vehicle 101 (e.g., as illustrated in FIGS. 1, 5A, 5B, 6, 7A, 7B, 8A, and/or 9, the vehicle 901 may be an example of the vehicle 101), a vision module to operate the vision sensor 208, a conveyor control module to operate conveyor 909 (e.g., as illustrated in FIG. 9), or a robotic arm control module to operate the robotic arm 103. The controller 201 may include a neural network 209. The data storage component 207 may store historical data 271 and feedback 272, such as data provided by a user of the track material handling system 100 or data gathered in the course of operation of the track material handling system 100.

The controller 201 may be any device or combination of components comprising the processor 204 and the memory component 202. The processor 204 may be any device capable of executing a machine-readable instruction set stored in the non-transitory computer-readable memory. The processor 204 may include any processing component(s) configured to receive and execute programming instructions (such as from the data storage component 207 and/or the memory component 202). The instructions may be in the form of a machine-readable instruction set stored in the data storage component 207 and/or the memory component 202. As examples, the processor 204 may include one or more chips, system-on-chips (SoCs), system-in-packages (SiPs), chipsets, packages, or devices that individually or collectively constitute or comprise a processing system. The processor 204 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processor 204 is communicatively coupled to the other components of the controller 201 by the local interface 203. The local interface 203 may communicatively couple any number of processors 204 with one another, and allow the components coupled to the local interface 203 to operate in a distributed computing environment. The local interface 203 may be implemented as a bus or other interface to facilitate communication among the components of the controller 201. While the aspect depicted in FIG. 2 includes a single processor, other aspects may include more than one processor.

The memory component 202 includes a non-transitory computer-readable memory. The memory component 202 may include RAM, ROM, a flash memory, a hard drive, other discrete gate or transistor logic or circuitry, or any non-transitory memory device capable of storing machine-readable instructions such that the machine-readable instructions can be accessed and executed by the processor 204. The machine-readable instruction set may include logic or algorithm(s) written in any programming language of any generation (e.g., 1GL, 2GL, 3GL, 4GL, or 5GL) such as, for example, machine language that may be directly executed by the processor 204, or assembly language, object-oriented programming (OOP), scripting languages, microcode, etc., that may be compiled or assembled into machine-readable instructions and stored in the memory component 202. Alternatively, the machine-readable instruction set may be written in a hardware description language (HDL), such as logic implemented via either a FPGA configuration or an ASIC, or their equivalents. Accordingly, the functionality described herein may be implemented in any conventional computer programming language, as pre-programmed hardware elements, or as a combination of hardware and software components. For example, the memory component 202 may be a machine-readable memory (which may also be referred to as a non-transitory processor-readable memory or medium) that stores instructions that, when executed by the processor 204, cause the processor 204 to perform a method or control scheme as described herein. While the aspect depicted in FIG. 2 includes a single non-transitory computer-readable memory component, other aspects may include more than one memory module. The memory component 202 may be used to store the one or more modules. The one or more modules, during operation, may be in the form of operating systems, application program modules, or other program modules. Such program modules may include, but are not limited to, routines, subroutines, programs, objects, components, and data structures for performing specific tasks or executing specific abstract data types according to the present disclosure as will be described below. For example, the program module may include the vehicle control module to operate the vehicle 101 (e.g., as illustrated in FIGS. 1, 5A, 5B, 6, 7A, 7B, 8A, and/or 9, the vehicle 901 may be an example of the vehicle 101), the vision module to operate the vision sensors 208, the conveyor control module to operate conveyor 909 (e.g., as illustrated in FIG. 9), and the robotic arm control module to operate the robotic arm 103 (e.g., as illustrated in FIGS. 1 and 3A-9).

The track material handling system 100 may be or include an artificial intelligence system such that the track material handling system 100 may make inferences and operate based on the collected visual information and data related to the railroad systems and environment. Particularly, the track material handling system 100 may have machine learning functions. The various modules may include one or more machine learning models. A machine learning model may include, for example, a neural network 209 or another form of machine learning model trained using a machine learning algorithm. The vehicle control module, the vision module, the conveyor control module, and/or the robotic arm control module may be trained and provided with machine learning capabilities via the neural network 209 as described herein. It should be noted that reference to “a/the neural network 209” can include a plurality of neural networks configured to control various functions or perform inferences based on various data. For example, a first neural network 209 may process visual data to identify a type of track material, and/or the track material having a character, and a second neural network 209 may determine whether the character of the track material satisfies an operation threshold.

The architecture of the neural network 209 may include, without limitation, a deep learning architecture or another form of architecture. The deep learning architecture may be, without limitation, a transformer-based architecture with self-attention, a feed-forward neural network, a recurrent neural network (RNN) architecture, a large language model (LLM), a natural language processing (NLP) model, a convolutional neural network (CNN), a generative model (e.g., a diffusion model), a vision transformer, or a multi-layer perceptron mixer. By way of example, and not as a limitation, the neural network 209 may utilize one or more artificial neural networks (ANNs). In ANNs, connections between nodes may form a directed acyclic graph (DAG). ANNs may include node inputs, one or more hidden activation layers, and node outputs, and may be utilized with activation functions in the one or more hidden activation layers such as a linear function, a step function, a logistic (sigmoid) function, a tanh function, a rectified linear unit (ReLu) function, or combinations thereof. Further, each of the various modules may include one or more generative artificial intelligence algorithms. The generative artificial intelligence algorithm may include a general adversarial network (GAN) that has two networks, such as a generator model and a discriminator model. The generative artificial intelligence algorithm may also be based on variation autoencoder (VAE) or transformer-based models.

The input/output interface 205 may include a monitor, keyboard, mouse, printer, camera, microphone, speaker, joystick, control panel, and/or another device for receiving, sending, and/or presenting data. The network interface 206 may include any wired or wireless networking hardware, such as a modem, LAN port, Wi-Fi card, WiMax card, mobile communications hardware, and/or other hardware for communicating with other networks and/or devices. The data storage component 207 may store the one or more modules, data collected in the course of operation of the track material handling system 100, configuration information for the track material handling system 100, or other data relevant to aspects described herein. The input/output interface 205 and/or the network interface 206 allow a user to send input to the controller 201 of the track material handling system 100 to control and manipulate the components of the track material handling system 100, such as the vision sensors 208, the robotic arm 103, and the vehicle 101, and receive output from the controller 201. The input/output interface 205 and the network interface 206 may connect to Internet of Things (IoT) devices in the track material handling system 100 to receive real-time or recorded image/video and sensory data. The IoT may include the network of physical devices, vehicles, buildings, and other objects that are embedded with sensors, software, and connectivity, enabling them to collect and exchange data over the internet. IoT devices, such as sensors, may monitor the condition of tracks, vehicles, robotic arms, or other railroad maintenance devices and equipment in real-time. The IoT devices may collect data on factors like vibration, temperature, or wear, which enables scheduling of repairs or replacements before breakdowns occur. The IoT devices may further allow the track material handling system 100 to remotely diagnose issues in manipulating the track material 155, such as tie plates, rails, and ties, and to remotely control the vehicle 101 and the robotic arm 103. As a non-limiting example, an IoT device may provide a character measurement indicating whether a track material has been subject to an operation threshold level of the character, such as strain or temperature. In some aspects, the controller 201 may connect to the IoT devices through the network interface 206 to acquire the images or the videos of the vehicle 101, the robotic arm 103, track material 155, rails, ties, the environment around the vehicle 101 and the railroad. The track material handling system 100 may monitor the installation, distribution, and other maintenance tasks via the vision sensor 208, IoT devices (in some aspects, the vision sensor 208 may be an IoT device), and/or any available resources for the purpose and transfer real-time and/or recorded data (such as videos, images, messages, status, warning, and instructions, etc.) to the user via wired or wireless connections, such as, without limitation, cellular connection (2G, 3G, 4G, 5G, or 6G), internet, and any radio-wave-based communication.

The vision sensor 208 may be any device having an array of sensing devices capable of detecting radiation in an ultraviolet wavelength band, a visible light wavelength band, or an infrared wavelength band. In some aspects, the track material handling system 100 may include multiple vision sensors 208, such as multiple vision sensors 208 of a same type or a first vision sensor 208 of a first type and a second vision sensor 208 of a second type. The multiple vision sensors 208 of a same type can expand the field of view and enhance coverage. The multiple vision sensors 208 with two or more types can provide different information, such as, without limitation, color, heat, or distance, operate in various environmental conditions (e.g., visible light, fog, and rain), and/or improve accuracy. Any operation by a vision sensor 208 described herein can be performed by multiple vision sensors 208, such as a first operation by a first vision sensor 208 and a second operation by a second vision sensor 208. The vision sensor 208 may have any resolution.

The vision sensor 208 may include a selection of, without limitation, a proximity sensor, a camera, a light detection and ranging (LIDAR) sensor, a thermal image sensor, an infrared sensor, an ultrasonic sensor, and/or a combination thereof. The camera may be, without limitation, a red-green-blue (RGB) camera, a depth camera, an infrared camera, a wide-angle camera, or a stereoscopic camera. The vision sensor 208 may be operable to acquire image or video data of the vehicle 101, the robotic arm 103, the rail 108, the tie 107, the track material 155, and the environments around the robotic arm 103, the vehicle 101, and/or the track material 155. The vision sensor 208 may be provided on the robotic arm 103 or the vehicle 101, or separately from the robotic arm 103 and the vehicle 101. In some aspects, the vision sensor 208 may be equipped, without limitation, on a smartphone, a tablet, a computer, a laptop, or a virtual head unit.

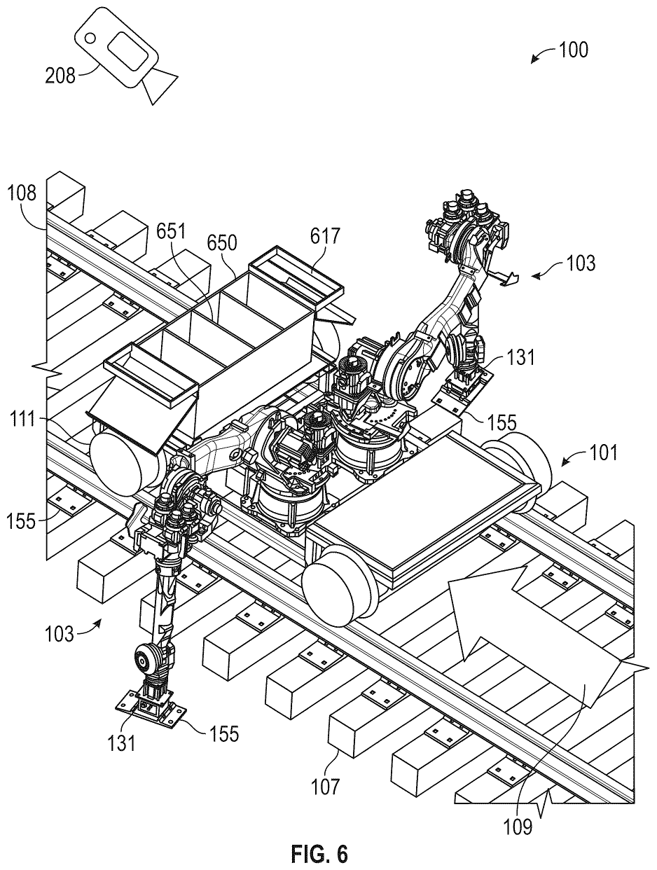

In some aspects, one or more optical components, such as a mirror, fish-eye lens, or any other type of lens may be optically coupled to the vision sensor 208. In some aspects described herein, the vision sensor 208 may provide image data to the processor 204 or another component communicatively coupled to the local interface 203. The image data may include image data of the environment around the vehicle 101 (e.g., as illustrated in FIGS. 1, 5A, 5B, 6, 7A, 7B, 8A, and/or 9, the vehicle 901 may be an example of the vehicle 101). The vision sensor 208 (e.g., based on neural network 209) may detect, without limitation, the track material 155, the target location 115, the containment beds 913 (e.g., as illustrated in FIG. 9), the conveyor 909 (e.g., as illustrated in FIG. 6), and/or the stationary position. The vision sensor 208 may operate in the visual and/or infrared spectrum to sense visual and/or infrared light. Additionally, while the particular aspects described herein are described with respect to hardware for sensing light in the visual and/or infrared spectrum, it is to be understood that other types of sensors are contemplated. For example, the systems described herein could include one or more LIDAR sensors, proximity sensors, radar sensors, sonar sensors, or other types of sensors, and such data could be integrated into or supplement the data collection described herein to develop images and videos.

In operation, the vision sensor 208 may capture image data and communicate the image data to the processor 204. The image data may be received by the processor 204, which may process the image data using one or more image processing algorithms. Any known or yet-to-be-developed video or image processing algorithms may be applied to the image data in order to identify an item or situation. Example video or image processing algorithms may include, but are not limited to, kernel-based tracking (such as, for example, mean-shift tracking) and contour processing algorithms. In general, video or image processing algorithms may detect objects and movements from sequential or individual frames of image data. One or more object recognition algorithms may be applied to the image data to extract objects and determine their relative locations to each other. Any known or yet-to-be-developed object recognition algorithms may be used to extract the objects or even optical characters and images from the image data. Example object recognition algorithms include, but are not limited to, scale-invariant feature transform (“SIFT”), speeded up robust features (“SURF”), and edge-detection algorithms. Particularly, the vision sensors 208 may detect and recognize, without limitation, ties, tie plates, spikes, anchors, rail fasteners, track maintenance equipment, rail welding materials, and any objects or parts of the railroad. The vision sensors 208 may detect whether the track material 155 is in a deviation orientation, the type of the track material 155. The vision sensor 208 may detect whether the track material 155 is used and/or spent. The vision sensor 208 may be further used to monitor the operations and functions of the robotic arm 103 and collaborate with the robotic arm 103 and other track maintenance equipment and tools to manipulate the track material 155. For example, the vision sensor 208 may monitor the robotic arm 103 placing the track material 155 on the tie 107 and determining whether the track material 155 is installed in a desired manner.

The track material handling system 100 may use the vision sensor 208 to identify a character of a track material 155 (e.g., a tie plate as illustrated in FIG. 1). Based on the character of the track material 155, the track material handling system 100 may use the neural network 209 to determine whether the character of the track material 155, satisfies an operation threshold for a rail assembly operation. It should be noted that the identification of the character of the track material 155 can also be performed by the neural network 209. That is, neural network 209 may include a track material vision algorithm. The track material handling system 100 may use the robotic arm 103 to place the track material 155 at a target location 115. In some aspects, the target location 115 may be located at the vehicle 101. In some aspects, the target location 115 may be an inspection location, such as, without limitation, an inspection location of a need for material, an inspection location of a placed material's alignment, an inspection location of a fill status, or any location of a need for inspection. In some aspects, the target location is at or proximate to an adjacent node. The adjacent node may be a rail, a tie, a container associated with the robotic arm 103 or the vehicle 101, a conveyor, or a rejection place. The controller 201 may receive inputs from the components of the track material handling system 100 and provide outputs to the components, such as, without limitation, an output triggering a movement of the robotic arm 103. The track material handling system 100 may use data collected by the vision sensor 208 to determine the quality of the track material. For example, the track material handling system 100 may use the neural network 209 to evaluate one or more track material conditions based on one or more defect conditions. A defect condition may indicate that a deformation, a corrosion, a deviation from an original manufacturing condition, a decay, a structural damage, or a combination thereof, is associated with a track material.

In operation, the vision sensor 208 may capture images of each track material 155 as the vehicle or the robot arm passes through an inspection area. The processor 204 may analyze the images using a track material vision algorithm to detect conditions (e.g., defects), such as, without limitation, improper installation of the track material, cracks, warping, deformed shape, or corrosion of the track material. In some aspects, machine-learning techniques may be used to train the track material vision algorithm to recognize the track material 155, various defect patterns and/or other structures that are desired for recognition. In some aspects, the vision sensor 208 may be used to inspect a new track material before placing the new track material on or in proximity to the target location 115. The vision sensor 208 may capture the images of the new track material and the processor 204 may use the track material vision algorithm to assess the quality of the track material 155, ensuring that the new track material meets standards and/or demands before being distributed and/or installed. Further, in some aspects, the vision sensor 208 may be used to capture images and the processor 204 may use the track material vision algorithm to recognize the specific features of each type of track material and further verify whether the deposited or distributed track material is the correct type being used based on their visual characteristics. Upon determining the existence of defects or an incorrect type, the processor 204 may replace or remove the defective or incorrect track material.

The controller 201 may be a component of the track material handling system 100. The controller 201 includes an input/output interface 205. The controller 201 may be a local controller that is included in the vehicle 101 or the robotic arm 103, or may be a remote controller that operates remotely from the vehicle 101 or the robotic arm 103. One or more connections (not illustrated) connect components of the track material handling system 100 to the controller 201 and allow signal transmission between the components of the track material handling system 100. A connection may be a wired connection, a wireless connection, or a combination thereof. The one or more connections may be formed from any medium that is capable of transmitting a signal, such as, for example, conductive wires, conductive traces, optical waveguides, or the like. In some aspects, the one or more connections may facilitate the transmission of wireless signals, such as according to a communication protocol (e.g., WiFi, Bluetooth®, Near Field Communication (NFC), or the like). Moreover, the one or more connections may be formed from a combination of media capable of transmitting signals. In some aspects, the one or more connections may include a combination of conductive traces, conductive wires, connectors, and/or buses that cooperate to permit the transmission of electrical data signals to components such as processors, memories, sensors, input devices, output devices, and/or communication devices. Accordingly, the one or more connections may include a vehicle bus, such as for example a Local Interconnect Network (LIN) bus, a Controller Area Network (CAN) bus, a Vehicle Area Network (VAN) bus, and the like. Additionally, it is noted that the term “signal” means a waveform (e.g., electrical, optical, magnetic, mechanical, or electromagnetic), such as direct current, alternating current, sinusoidal-wave, triangular-wave, square-wave, vibration, and the like, capable of traveling through a medium.

In some aspects, the controller 201 may communicate with the components of the track material handling system 100 through wireless communication technologies, such as, without limitation, radio frequency (RF) communication, Bluetooth (a short-range wireless communication technology), Wi-Fi (a local wireless network based on IEEE 802.11 standards), Zigbee (a low-power, short-range wireless technology based on IEEE 802.15.4 standards), Z-Wave (a mesh network using low energy radio waves), a cellular radio access technology (such as 2G, 3G, 4G, 5G, or 6G), a sidelink technology, satellite communication, or Narrowband Internet of Things (NB-IoT, a low-power wide-area network radio technology). The controller 201 may monitor, operate, and/or control the vehicle 101, the robotic arm 103, and/or the vision sensors 208. For example, the controller 201 can be used (in some aspects, by a user) to operate the vision sensors 208 such that the vision sensors 208 inspect the track material 155 and/or railway systems when the robotic arm 103 and/or vehicle 101 moves on or along the railroad track. The performance of the vehicle 101 and/or the robotic arm 103 may be monitored (in some aspects, by a user) and the operations of the vehicle 101 and/or the robotic arm 103 may be changed or updated based on the performance (in some aspects, by a user). Further, data from the vehicle 101 (such as the number of track materials picked up or deposited, any error conditions, and/or any general operating data) may be monitored (in some aspects, by a user or by the controller 201).

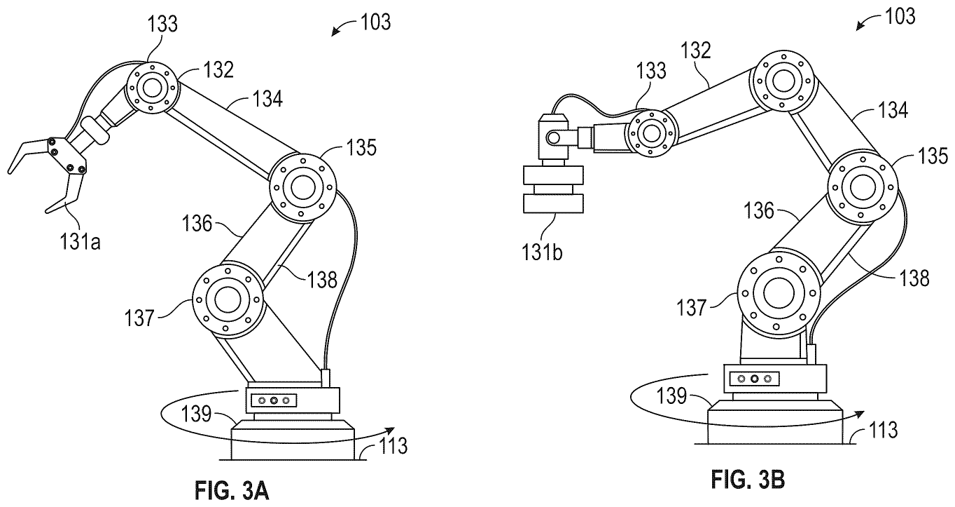

FIGS. 3A and 3B provide additional views of the robotic arm 103. As shown, in some aspects, the robotic arm 103 may include a base 139, a shoulder joint 137, one or more members (such as a front member 134 and a rear member 136), a wrist joint 133, and the retaining mechanism 131. The base 139 may include a top part and a bottom part. The members 134 and 136 may include a first end 138 and a second end 132. For example, the first end 138 may be provided proximate to shoulder joint 137 and the second end 132 may be provided proximate to wrist joint 133. The members 134 and 136 may be mechanically coupled with each other through one or more member joints 135. The base 139 may be mechanically coupled to the chassis 113 of the vehicle 101 at the bottom part. The base 139 may be pivotally coupled to the first end 138 of the rear member 136 with the shoulder joint 137 at the top part of the base 139, and the second end 132 of the front member 134 may be pivotally coupled to the retaining mechanism 131 with the wrist joint 133.

In some aspects, the retaining mechanism 131 may include, without limitation, an impactive end effector 131a, an ingressive end effector, an astrictive end effector 131b, or a contigutive end effector. The impactive end effector 131a may be a jaw or claw-like effector that physically grasps the object to relocate or reorient track material 155 based on the need. The ingressive end effector may include, for example, pins, needles, or hackles to physically penetrate the surface of the objects or hook the objects through a hole in the object. In some aspects, the astrictive end effector 131b may include, without limitation, one of a magnet, an electromagnet, a permanent magnet, or a combination thereof. The astrictive end effector 131b may include a vacuum, a magneto, or an electro-adhesion mechanism to create an attractive force that is then applied to the objects in order to grasp the objects. The contigutive end effector may create adhesive force between the effector and the object through direct contact such as, without limitation, gluing, surface tension, or freezing.

In some aspects, the retaining mechanism 131 of the robotic arm 103 may include, without limitation, one of a magnet, an electromagnet, a permanent magnet, or a combination thereof. The controller 201 may control the retaining mechanism 131 (e.g., as the electromagnet) to produce or restrain from producing a magnetic field to attract (for lifting and holding) or release the track material 155, respectively. The retaining mechanism 131 may include a mechanical part to overcome the magnetic attractive force and release the track material 155 held by the retaining mechanism 131, for example, when the retaining mechanism 131 (e.g., as the permanent magnet) constantly produces magnetic fields. For example, as illustrated in FIG. 1, each robotic arm 103 employs a retaining mechanism 131, which lifts one track material 155 per retaining mechanism 131 from the ground on the side of the rail 108 by using magnetic attractive force.

In some aspects, the robotic arm 103 may have a plurality of degrees of freedom. The number of degrees of freedom may be, without limitation, from 2 to 10, from 2 to 8, or from 2 to 6. Throughout the disclosure, six degrees of freedom refers to the six mechanical degrees of freedom of movement of a rigid body in three-dimensional space, including changes in position in three perpendicular axes as forward/backward (surge), up/down (heave), left/right (sway) and changes in orientation through rotation about three perpendicular axes as yaw (normal axis), pitch (transverse axis), and roll (longitudinal axis). For example, as illustrated in FIGS. 3A-3B, the robotic arm 103 may rotate via the base 139 having a yaw degree of freedom. The shoulder joint 137 adds a roll degree of freedom to the front member 134 and the rear member 136. The member joint 135 adds a roll or a pitch degree of freedom to the front member 134. The wrist joint 133 adds a yaw, a roll, or a pitch degree of freedom to the retaining mechanism 131. The impactive end effector 131a, illustrated in FIG. 3A as the retaining mechanism 131, adds a surge or a sway degree of freedom to the robotic arm 103.

Referring back to FIG. 1, the track material handling system 100 is depicted manipulating track material 155. The track material 155 may be in an assembled position, a distributed position, or a reinstallation position. The assembled position is a position in which the track material 155 is installed for use within a rail system. For example, a tie plate may be installed between the rail 108 and the tie 107. The distributed position is a position in which the track material 155 is placed before installation along a track bed. For example, a tie plate may be distributed and placed on or near the tie 107 to be installed. The reinstallation position is a position in which the track material is relocated from the assembled position along a track bed. For example, the tie plate may be uninstalled from the installed position and placed next to the tie 107 for reinstallation during an inspection process. The track material 155 may be a track material in a plurality of track materials in a bin, in a pile, or on a conveyor.

In some aspects, the track material handling system 100 may identify the track material 155 as having a character using the vision sensor 208. The character of the track material 155 may include, without limitation, a size, a shape, a weight, a hole pattern, a model, an assembly arrangement, or a quality. Specific examples of how the character is used to determine whether the character of the track material satisfies an operation threshold are provided elsewhere herein. The track material handling system 100 may determine the quality of the track material 155 by evaluating one or more track material conditions against one or more defect conditions. The one or more defect conditions may include, without limitation, a deformation, a corrosion, a deviation from an original manufacturing condition, a decay, or a structural damage.

The track material handling system 100 may use the neural network 209 to determine whether the character the track material 155 for a rail assembly operation satisfies an operation threshold. For example, the track material handling system 100 may input one or more characters of the track material 155 and one or more operation conditions of the track material 155 into the neural network 209. The characters may include, without limitation, the size, the shape, the weight, the hole pattern, and/or the model of the track material 155. The operation conditions may include, without limitation, compatibility of the mating track components of the track material 155, operation temperature extremes (e.g., high operation temperature, low operation temperature, operation thermal cycling), operation moisture and humidity (e.g., operation water resistance, freeze-thaw resistance, absorption limits), operation corrosion and/or chemical exposure, operation ultraviolet and solar radiation, soil acidity/alkalinity, operation dust/particulate exposure, and/or operation altitude and atmosphere pressure. The neural network 209 may generate an operability value of the track material against the operation conditions. The neural network 209 may compare the operation value with the operation threshold to further determine whether the track material 155 may satisfy a desired operation under the operation condition. The operation threshold may be manually input or calculated based on previous desired or undesired characters of example track materials under different operation conditions.

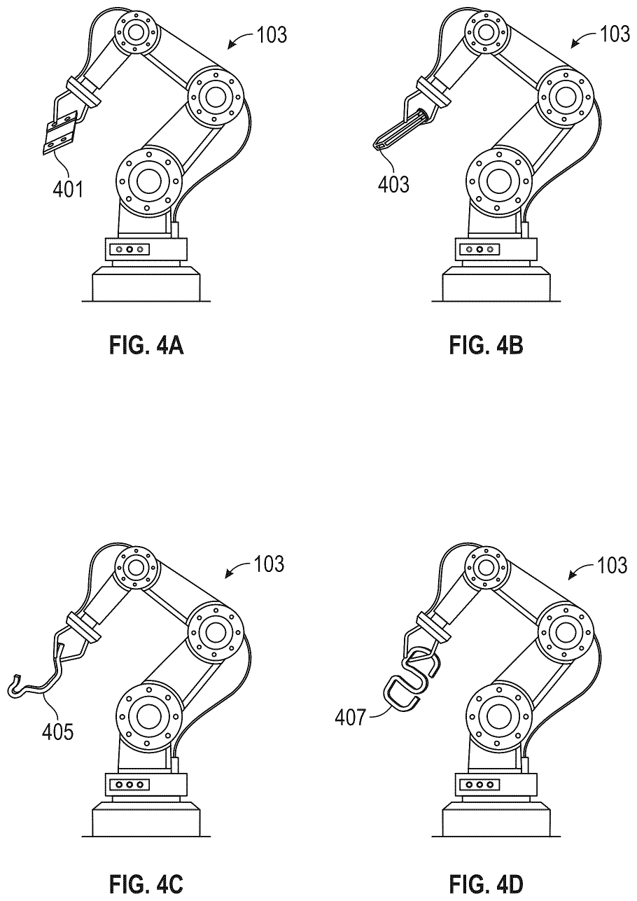

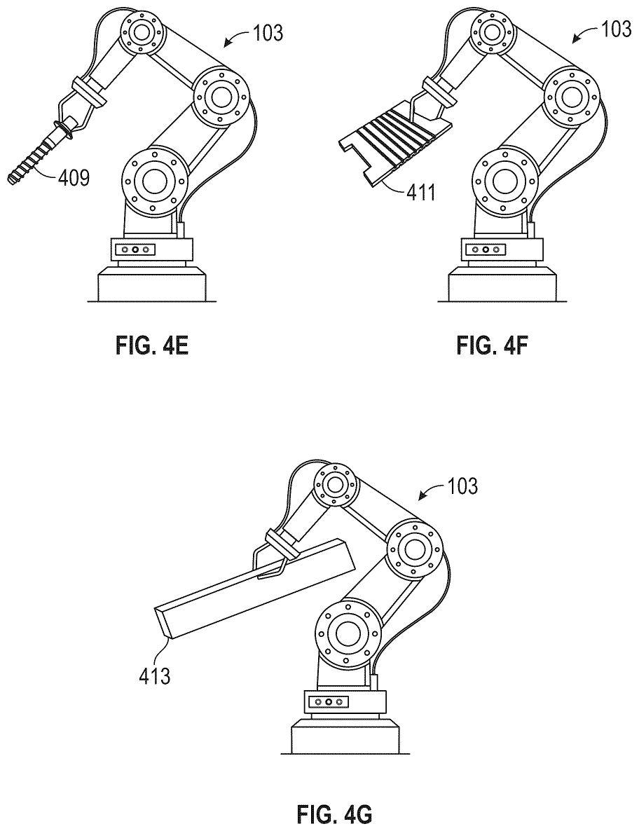

The track material handling system 100 may use the robotic arm 103 to handle the track material according to the determination. The rail assembly operation may include, without limitation, installation, replacement, distribution, removal, bundling, sliding, loading, or a combination thereof, related to a track. For example, the track material handling system 100 may use the robotic arm to place the track material 155 at the target location 115. The target location 115 may be at one or more of a job site, a rail side area, or a factory, among other examples. The target location 115 may include, without limitation, one or more of the rail 108, the tie 107, the container 650 (e.g., in FIG. 6) associated with the robotic arm 103 or the vehicle 101, a conveyor (e.g., the conveyor 909 in FIG. 9), or a rejection place. The rejection place may include, without limitation, one or more of a discard container, a discard chute, a discard pallet, or a discard conveyor. In operation, in some aspects, the track material handling system 100, in response to determining that the character of the track material 155 satisfies the operation threshold, the track material handling system 100 may use the robotic arm 103 to place the track material 155 at or near, without limitation, the rail 108, the tie 107, the container 650 associated with the robotic arm 103 or the vehicle 101, or the conveyor. The track material handling system 100 may, in response to determining that the character fails to satisfy the operation threshold, use the robotic arm 103 to place the track material 155 at or near, without limitation, the discard container, the discard chute, the discard pallet, or a discard conveyor. In some aspects, the track material handling system 100 may not, in response to determining that the character fails to satisfy the operation threshold, pick up the track material 155 or place the track material 155 at another place. In some aspects, the track material handling system 100 may use the track material in assembling a railroad track. For example, the track material handling system 100 may use the robotic arm 103 to drive a spike 403 (e.g., in FIG. 4B) into the tie 107.

In some aspects, the track material handling system 100 may inspect the character of the track material 155 without using the robotic arm 103 to pick up the track material 155. In some aspects, the track material handling system 100 may use the robotic arm 103 to lift the track material 155 before identifying the character of the track material 155. For example, the track material 155 may be lifted from a plurality of track materials in a bin, in a pile, or on a conveyor. In some aspects, the track material handling system 100 may use the robotic arm 103 to lift the track material 155 after identifying the character of the track material 155.

In some aspects, the robotic arm 103 may be mechanically coupled to the vehicle 101. The vehicle 101 may move on the rail 108. Vision sensor 208 may capture image data of the vehicle 101, the robotic arm 103, and the environment (including the track material 155, the rail 108, and the ties 107). In some aspects, the track material handling system 100 may use each of multiple vision sensors 208 to monitor different components of the track material handling system 100. In some other aspects, the track material handling system 100 may assign each of the multiple vision sensors 208 to monitor a specific component of the track material handling system 100. For example, the track material handling system 100 may assign each of multiple vision sensors 208 to a group of multiple groups, where each group of the vision sensors 208 may be assigned to capture the images and videos of one or more of the vehicle 101, the robotic arm 103, the track material 155, the rail 108, or the ties 107. The vehicle 101 may move along the path 109 that may be defined by the rail 108 and/or ties 107. During the track material handling, the vision sensors 208 may detect the track material 155 along the path, and the track material handling system 100 may handle the track material 155 based on the character identification of the track material 155 and a current task of rail assembly operations.

In some aspects, the robotic arm 103 may place a stored track material from the target location 115, such as a container (e.g., container 650, depicted in FIG. 6) on or near the tie 107 or the rail 108 for rail assembly operations. In some aspects, the robotic arm 103 may deposit the track material 155 into the target location 115, such as the container. In some aspects, after the vision sensor 208 detects that the lifted track material 155 is in a deviation orientation, the robotic arm 103 may place the track material 155 in the flipping station 617 to adjust the orientation of the track material 155. In some aspects, when the vehicle 101 passes a stationary position, where one or more track materials 155 may be stored, the robotic arm 103 may be capable of transferring the track material 155 from the stationary position to the target location 115, such as the container 650.

Referring to FIGS. 4A-4G, the track material handling system 100 may be used to handle various types of track material 155, such as, without limitation, a tie plate 401, a spike 403, an anchor 405, a clip 407, a screw 409, a crosstie 413, or a pad 411. The track material handling system 100 may conduct various rail assembly operations on the track material 155, for example, without limitation, installation, replacement, distribution, removal, bundling, sliding, loading, or a combination thereof, related to the track. Specific examples of these operations are provided below.

In FIG. 4A, in some aspects, the track material handling system 100 may recognize the tie plate 401. The track material handling system 100 may install the tie plate 401, tilting parallel rails inward to manage side loads, which vary depending on track curvature, locomotive velocity, and/or weight. For example, the track material handling system 100 may install the tie plate 401 on top of crossties, ensuring desired rail seating. As another example, the track material handling system 100 may remove old and damaged tie plates 401 during track upgrades or maintenance. The robotic arm 103 may align and fasten the tie plate 401 to maintain track stability and alignment. The track material handling system 100 may characterize the tie plate 401 by size, shape, weight, or hole patterns. The track material handling system 100 may perform a quality evaluation on the tie plate 401 based on deformation, broken corners, structural cracks, or incomplete profiles caused by manufacturing defects. The track material handling system 100 may use the robotic arm 103 to handle the tie plate 401 by, without limitation, sorting by quality or classification, loading the tie plates into machines, palletizing for shipping, dispensing onto railway tracks, or picking and/or placing the tie plate 401 during maintenance activities. For example, the track material handling system 100 may use the robotic arm 103 to sort the tie plate 401 based on, without limitation, surface defects, dimensions, material integrity, size, weight, design features of the tie plate 401, or a combination thereof. In some aspects, the track material handling system 100 may evaluate the quality of the tie plate 401 based on, without limitation, surface defects, dimensions, material integrity, size, weight, design features of the tie plate 401, or a combination thereof.

In FIG. 4B, in some aspects, the track material handling system 100 may recognize the spike 403. For example, the track material handling system 100 may manage the spike 403 by extracting worn or corroded spikes 403 and/or driving new spikes into the ties using an automated mechanism. Removed spikes 403 can be placed in a rejection place for recycling or disposal, thus enhancing efficient material handling. The track material handling system 100 may classify the spike 403 by the length and shape of the spike 403, and evaluate the spike 403 for defects, such as deformation or incomplete profiles caused by errors in manufacturing. The track material handling system 100 may use the robotic arm 103 to handle the spike 403 for sorting by quality or classification, palletizing for shipping, loading into machines for installation, dispensing onto tracks, and picking or removing the spike 403 from tracks during maintenance operations, such as pulling the spike 403 out of wooden crossties. For example, the track material handling system 100 may use the robotic arm 103 to sort the spike 403 based on, without limitation, surface defects, dimensions, material integrity, size, weight, design features of the spike 403, or a combination thereof. In some aspects, the track material handling system 100 may evaluate the quality of the spike 403 based on, without limitation, surface defects, dimensions, material integrity, size, weight, design features of the spike 403, or a combination thereof.

In FIG. 4C, in some aspects, the track material handling system 100 may recognize the anchor 405. The track material handling system 100 may classify the anchor 405 based on the length, shape, and/or weight of the anchor 405, and perform quality inspections based on deformation and/or profile completeness. The track material handling system 100 may handle the anchor 405 through sorting by quality or classification, palletizing for shipping, and/or loading into machines for installation. The track material handling system 100 may dispense the anchor 405 onto tracks for final placement, pick the anchor 405 up during maintenance, and/or adjust the anchor 405 along the rail 108 to facilitate tasks like tie replacement or alignment corrections. The track material handling system 100 may install anchor 405 to secure the rails and reduce longitudinal movement to enhance the track stability. The track material handling system 100 may adjust anchor 405 by sliding the anchor 405 along the rail 108 to account for thermal expansion and contraction. For example, the track material handling system 100 may use the robotic arm 103 to sort the anchor 405 based on, without limitation, surface defects, dimensions, material integrity, size, weight, design features of the spike 403, or a combination thereof. In some aspects, the track material handling system 100 may evaluate the quality of the anchor 405 based on, without limitation, surface defects, dimensions, material integrity, size, weight, design features of the anchor 405, or a combination thereof.

In FIG. 4D, in some aspects, the track material handling system 100 may recognize the clip 407. The track material handling system 100 may classify the clip 407 by, without limitation, length, shape, and/or weight. The track material handling system 100 may evaluate the clip 407 for deformation and/or profile completeness. The track material handling system 100 may handle the clip 407 by, without limitation, sorting by quality or classification, palletizing for shipping, loading into machines for installation, and/or dispensing onto tracks for intermediate or final positioning. For example, the track material handling system 100 may use the robotic arm 103 to sort the clip 407 based on, without limitation, surface defects, dimensions, material integrity, size, weight, design features of the clip 407, or a combination thereof. In some aspects, the track material handling system 100 may evaluate the quality of the clip 407 based on, without limitation, surface defects, dimensions, material integrity, size, weight, design features of the clip 407, or a combination thereof. The track material handling system 100 may position the clip 407 at desired intervals during track assembly or detach the clip 407 during disassembly, providing flexibility and reusability of the clip 407. The track material handling system 100 may pick up the clip 407 for removal or repositioning during maintenance.

In FIG. 4E, in some aspects, the track material handling system 100 may recognize the screw 409. The track material handling system 100 may classify the screw 409 by, without limitation, length, shape, and/or weight. The track material handling system 100 may perform quality evaluations on the screw 409 based on deformation and/or manufacturing flaws. The track material handling system 100 may handle the screw 409 by, without limitation, sorting by quality or classification, palletizing for shipping, loading into machines for installation, dispensing onto tracks near or into their final positions. As another example, the track material handling system 100 may handle screws 409 during track disassembly or maintenance by picking up or removing screws 409 as needed. For example, the track material handling system 100 may use the robotic arm 103 to sort the screw 409 based on, without limitation, surface defects, dimensions, material integrity, size, weight, design features of the screw 409, or a combination thereof. In some aspects, the track material handling system 100 may evaluate the quality of the screw 409 based on, without limitation, surface defects, dimensions, material integrity, size, weight, design features of the screw 409, or a combination thereof. The track material handling system 100 may automate the distribution and installation of the screw 409, placing the screw 409 along the track and securing the screw 409 into crossties or plates with retaining mechanism 131 having fastening tools, such as powered drivers. The track material handling system 100 may facilitate removal and collection of screw 409 when disassembling track sections.

In FIG. 4F, in some aspects, the track material handling system 100 may recognize the pad 411. The track material handling system 100 may classify the pad 411 by length, shape, and/or weight. The track material handling system 100 may inspect the pad 411 for deformation or incomplete profiles. The track material handling system 100 may handle the pad 411 through sorting by quality or classification, palletizing for shipping, loading into machines for placement, dispensing onto tracks for final positioning, and/or removing them during track disassembly or maintenance. The track material handling system 100 may handle the pad 411 by placing the pad 411 beneath the rails 108 to absorb vibrations and/or reduce wear on the crossties. The track material handling system 100 may remove and/or replace a damaged pad 411. For example, the track material handling system 100 may use the robotic arm 103 to sort the pad 411 based on, without limitation, surface defects, dimensions, material integrity, size, weight, design features of the pad 411, or a combination thereof. In some aspects, the track material handling system 100 may evaluate the quality of the pad 411 based on, without limitation, surface defects, dimensions, material integrity, size, weight, design features of the pad 411, or a combination thereof.

In FIG. 4G, in some aspects, the track material handling system 100 may recognize the crosstie 413 (e.g., a wooden crosstie and/or a concrete sleeper). The track material handling system 100 may classify the crosstie 413 by, without limitation, length, shape, and/or weight. The track material handling system 100 may evaluate the quality of the crosstie 413 based on, without limitation, deformation, structural damage, decay, and/or manufacturing defects. The track material handling system 100 may handle the crosstie 413 through sorting by quality or classification, bundling for shipping, loading into equipment for distribution, staging near installation sites, placing the crosstie 413 beneath the rail 108, and/or picking the crosstie 413 up for site removal or disassembly during maintenance. For example, the track material handling system 100 may use the robotic arm 103 to sort the crosstie 413 based on, without limitation, surface defects, dimensions, material integrity, size, weight, design features of the crosstie 413, or a combination thereof. The track material handling system 100 may lift and/or position the crosstie 413 along the track bed with a desired degree of precision. The track material handling system 100 may replace a deteriorated crosstie 413, providing minimal disruption to adjacent track sections during the process.

In some aspects, the track material handling system 100 may combine multiple operations, such as, without limitation, installing the tie plate 401, the anchor 405, and/or the clip 407 simultaneously during track construction, or removing and/or bundling the screw 409, the spike 403, and/or the tie plate 401 during track deconstruction.

Referring to FIGS. 1, 5A, 5B, and 6, the vehicle 101 may be, without limitation, a railcar, a rail truck, or a road-rail vehicle. The vehicle 101 may move on the motion mechanism 111 along a path. The motion mechanism 111 of the vehicle 101 may be, without limitation, a selection of rubber wheels, rail wheels, continuous tracks, or a combination thereof. The vehicle 101 may operably move on a path 109. In some aspects, the path 109 may be along the rail 108. The rail 108 may be installed on a plurality of the ties 107. Between the rail 108 and each tie 107, the track material 155 may be installed to mechanically couple the rail 108 and tie 107.

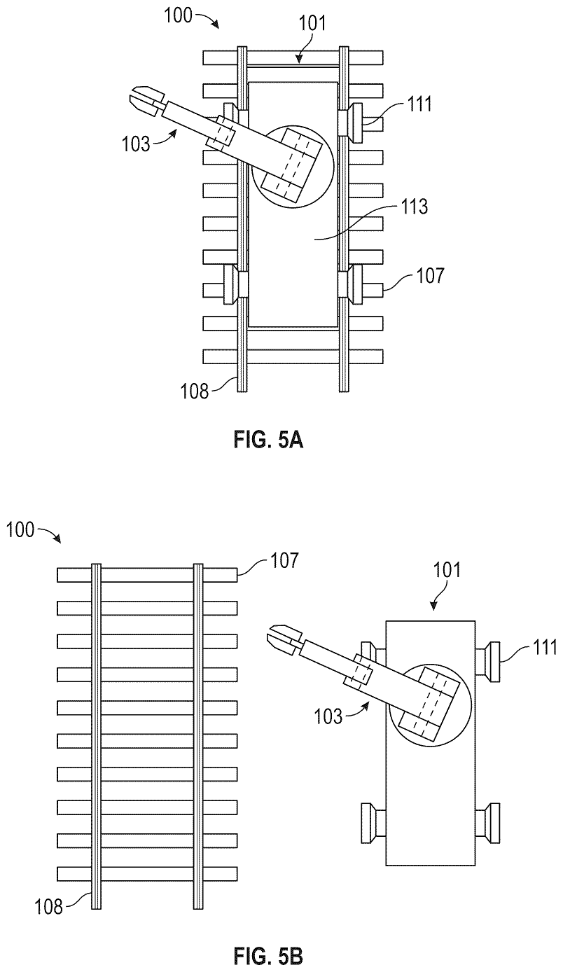

In some aspects, as illustrated in FIG. 5A, the vehicle 101 may move on the rail 108. In some aspects, as illustrated in FIG. 5B, the vehicle 101 may move along the path adjacent to the rail 108. The vehicle 101 may be, without limitation, a railcar, a rail truck, a road-rail vehicle, or an automobile (e.g., a sport utility vehicle (SUV)). The motion mechanism 111 of the vehicle 101 may include one or more of, without limitation, rubber wheels, rail wheels, flanged wheels, metal wheels, continuous tracks (e.g., metal link tracks, rubber tracks, single pin tracks, and/or double pin tracks), or a combination thereof. In some aspects, the vehicle 101 may move along the path 109 (as illustrated in FIGS. 1 and 6) by moving on the rail 108 using rail wheels or other types of wheels or tracks allowing the vehicle 101 to move on the rail 108. In some aspects, the vehicle 101 may move off the rail 108 using motion mechanism 111 in types allowing the vehicle 101 to move on an off-rail surface (as illustrated in FIG. 5B).

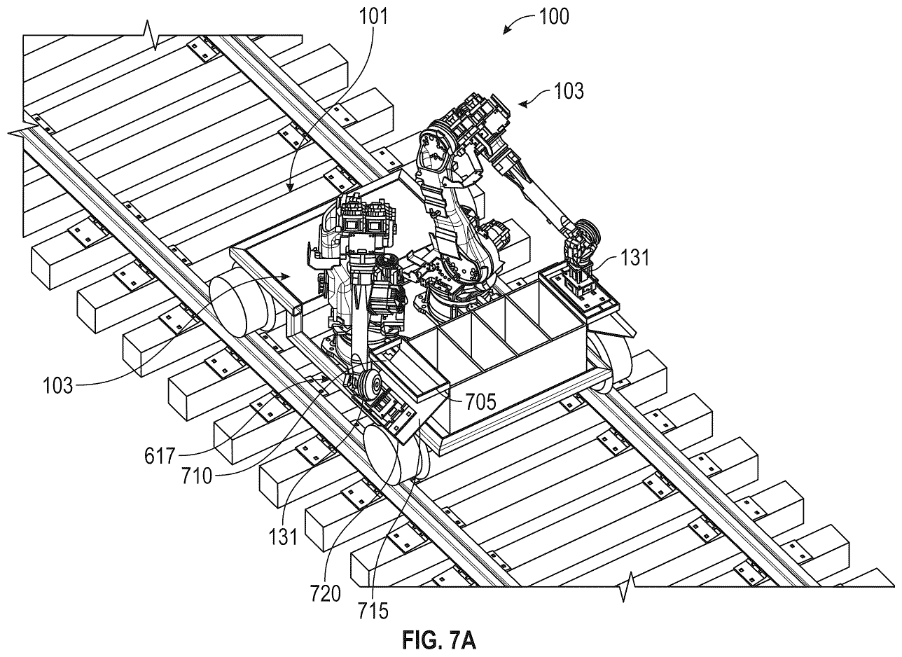

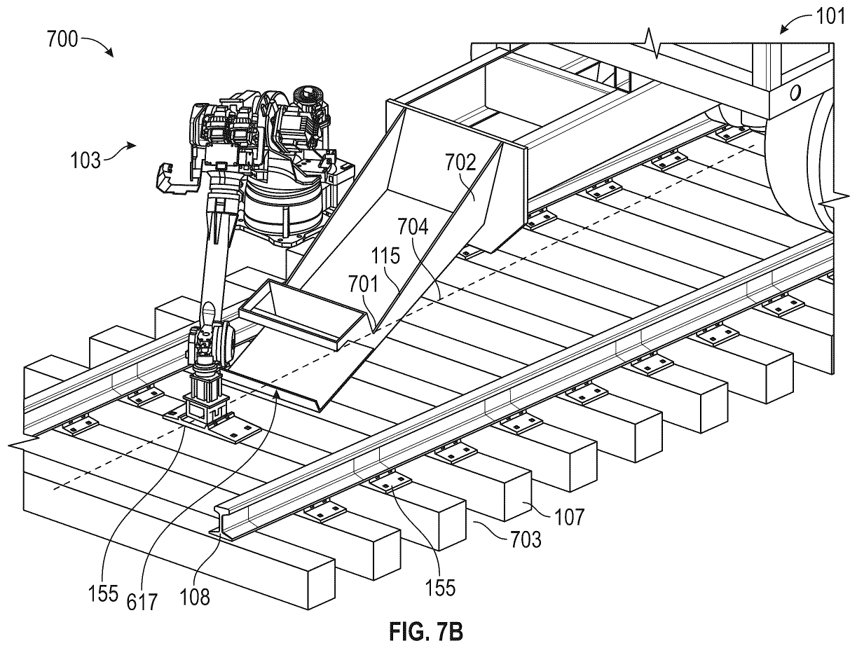

In some aspects, for example, as illustrated in FIG. 6, the vehicle 101 may further include a container 650 as the target location 115. The container 650 may be used to store track material 155. The container 650 may have multiple slots 651. For example, as illustrated in FIG. 6, the container 650 may include four slots 651. The container 650 may be within the reach of the robotic arm 103. The vehicle 101 may further include one or more flipping stations 617. In some aspects, as illustrated in FIGS. 6 and 7A, the flipping station 617 may be attached to the container 650. The flipping station 617 may be within the reach of the robotic arm 103. The flipping station 617 may be used to manipulate an orientation of the track material 155 lifted by the robotic arm 103. In some aspects, the orientations of the track material 155 may be upside down or in other deviation orientations that are not in alignment with the designated position for the track material 155 to be placed. The flipping station 617 may flip or re-orient the track material 155 to be in alignment with the designated position to be placed. Details regarding the flipping station 617 and the mechanism of track material flipping and/or reorientation are provided below.

Referring to FIGS. 6 and 7A-7B, the track material handling system 100 having one or more flipping stations 617 is depicted. The flipping station 617 may be powered or powerless. The flipping station 617 may use a mechanical leverage system having, without limitation, levers, pulleys, or inclined planes to change an orientation of the track material 155. For example, as illustrated in FIG. 7A, the flipping station 617 may include an aperture 705, an aperture brace 710, a sliding surface 715 (e.g., a slope beneath the aperture 705 and the aperture brace 710), and/or an arresting fixture 720 at the lower end of the sliding surface 715. Aperture 705 may have an opening defined by a set of walls or other members, with a diameter (e.g., cross-sectional size, width) sufficient to allow a track material 155 to pass through. The aperture brace 710 may be at one side of the aperture 705 to temporarily hold one side of the track material 155 when the other side of the track material 155 may fall through the aperture 705. The track material 155 that falls through the aperture 705 may flip and be captured by the sliding surface 715. The flipped track material 155 may slide on the sliding surface 715 and be captured by the arresting fixture 720. Similar structures can be implemented to reorient the track material 155 in different dimensions.

In some aspects, the controller 201 (e.g., using vision sensor 208) may locate a track material 155 for the robotic arm 103 to lift. After the robotic arm 103 lifts the track material 155, the vision sensors 208 may further detect that the track material 155 lifted by the robotic arm 103 is upside down or in some other deviation orientation that is not in alignment with a designated position in which the track material 155 is to be placed. A deviation orientation may include, without limitation, an angular deviation, a face-to-rail misalignment (e.g., when a tie plate face is upside down), gauge misalignment, or fastener hole misalignment (e.g., the orientation of the tie plate causing a hole for a fastener to misalign with a tie). The robotic arm 103 may lift the track material 155 and place the track material 155 at the aperture 705 of the flipping station 617. After the track material 155 is flipped or reoriented through the flipping station 617, the robotic arm 103 may lift the flipped track material 155 from the sliding surface 715. The vision sensor 208 may be used to confirm the flipped track material 155 is in alignment with the designated position for the flipped track material 155 to be placed, for example, on or near the tie 107 or the rail 108.

Referring to FIG. 7B, the track material handling system 700, lifting and placing the track material 155 (such as a tie plate) during the track material distribution, is depicted. Notably, FIG. 7B illustrates an aspect in which the track material handling system 100 has a single robotic arm 103. The vehicle 101 may move on the rail 108 with the container 650 at one end of the vehicle 101. The robotic arm 103 may be coupled to the vehicle 101 around the container 650 at the end of the vehicle 101. The flipping station 617 may be coupled to the container 650 at a first end 701, and a second end 702 of the container 650 may be coupled to the vehicle 101. The robotic arm 103 may lift the track material 155 from the container 650 and place the track material 155 on or near the tie 107. In some aspects, it may be desirable to deposit the track material 155 along a centerline 704 of the railroad ties 107 (the centerline 704 is illustrated some distance above a surface of the ties 107, thus appearing off-center in FIG. 7B). In some aspects, it may be desirable to position the track material 155 on the centerline 704 of the railroad ties 107 near ends of the ties 107, or on the ballast 703 near ends of the railroad tie 107. A straight portion of the rail 108 will have ties 107 laid on longitudinal centerlines which are, for example and without limitation, about nineteen point five inches (19.5″) or about twenty-two inches (22″) apart, as measured along rail 108. It should be understood that this dimension may vary between differing railroad operators and differing terrain conditions, such as for example bridges which may be more closely spaced. As the track material 155 is deposited, one or more workmen who follow behind the vehicle 101 may replace old tie plates on each individual tie 107 after the old tie plates have been removed with the new track material 155, preparatory to placement of new rails or replacement of old rails (referred to as target rails) on the newly placed tie plates.

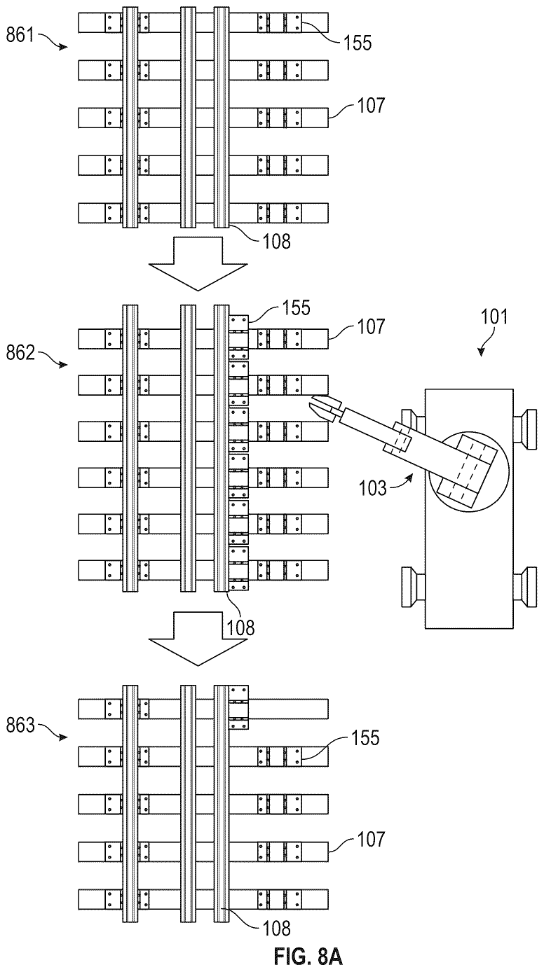

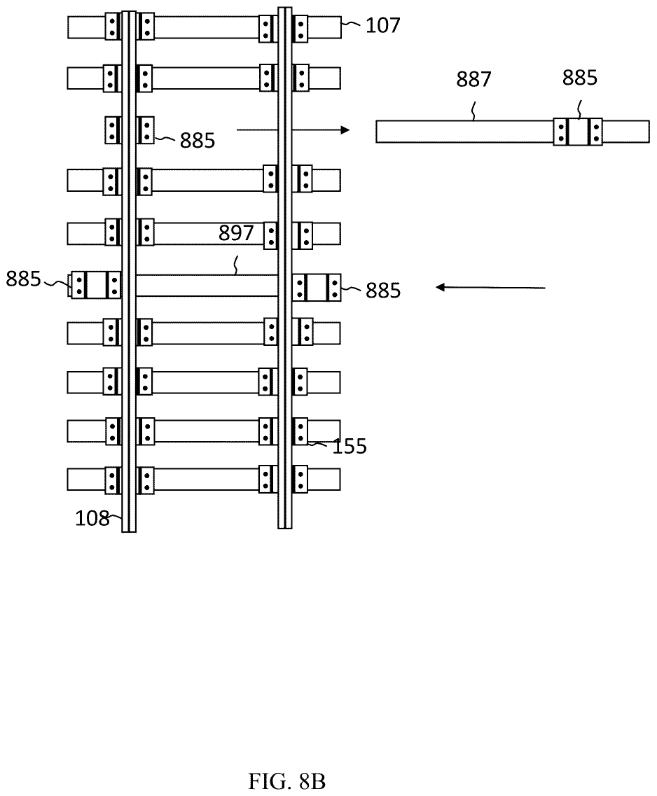

Referring to FIGS. 8A and 8B, the track material handling system 100 is demonstrated in examples of track material handling during tie inspection and replacement. In FIG. 8A, the process unfolds as follows. In step 861, a side of the rail may be removed, exposing the track material underneath for manipulation. In step 862, with one or more rails 108 positioned centrally on the ties, as depicted, the vehicle 101 may move alongside the rail 108 in step 862. Using the robotic arm 103, the track material handling system 100 may lift track material 155 from installed locations and relocate the track material 155 to a position (such as a position adjacent to the rails 108 at a center area of the ties 107). This relocation of the track material 155 allows thorough inspection of the ties 107. The ties 107 may be inspected by a worker or by the track material handling system 100 using the vision sensor 208. In step 863, once the inspection of the ties 107 is complete, for example by vision sensor 208 or manually, the robotic arm 103 may return the track material 155 from the center area of the ties 107 to their original installation positions. The removed rail or a new rail 108 may next be placed on top of the exposed track material 155.

Turning to FIG. 8B, when a replacement tie 887 is identified for replacement, one track material 155 may be removed and a replacement track material 885 may be pulled out, in the opposite direction from a direction in which the track material 155 is removed, from beneath rail 108 to one side of the railroad. After the replacement tie 887 is pulled out from beneath the rail 108, the track material 885 may ride on the replacement tie 887 or may remain in the installation position under the rail 108 (both approaches are illustrated here). The vehicle 101 may move adjacent to the replacement track material 885, and the robotic arm 103 (e.g., as illustrated in FIGS. 1, 3A-3B) may pick up the track material 885. Then, a new tie 897 may be inserted beneath the rails 108, and the robotic arm 103 may place the track material 885 on or in proximity to the new tie 897.

Referring to FIG. 9, a track material handling system 900 including one or more containment beds 913 and a conveyor 909 is depicted. The track material handling system 900 may include a vehicle 901. The vehicle 901 is an example of vehicle 101 and has motion mechanisms 911 such as rail wheels, one or more containment beds 913 extending in a longitudinal direction of the vehicle 901, a path 931 extending longitudinally on the vehicle 901 and adjacent to the containment beds 913, the robotic arm 103 disposed on the path 931, and a conveyor 909 extending along the vehicle 901 and within a reach of the robotic arm 103. The vehicle 901 may be a self-propelled vehicle and include an engine or motor to propel the vehicle along the railroad track and for on-road usage. The vehicle 901 may be, without limitation, a railcar or a rail-truck.

The conveyor 909 may be, without limitation, a belt conveyor or a roller conveyor. The conveyor 909 may be a powered conveyor, a non-powered conveyor, or a combination thereof. It should be noted that the term “conveyor” is illustrative. Conveyor 909 is not limited to a traditional belt or roller conveyor, and may be various forms of mover devices. For example, the term “conveyor” as used herein may refer to a roller conveyor, a chute, a gravity feeder, a vibratory feeder, or any other device or mechanism capable of conveying the track material 155 from a first position to a second position. In some examples, a conveyor 909 may include multiple sections. For example, a first section of a conveyor 909 may be provided “upstream” from the robotic arm 103, and may feed track material such as track material 155 to the robotic arm 103. The robotic arm 103 may place the track material on a second section of the conveyor 909.

The one or more containment beds 913 may be capable of containing a plurality of track materials 155. The robotic arm 103 is moveable along the path 931 in the longitudinal direction. The path 931 may be referred to herein as a machine path. The containment beds 913 allow for placement and storage of track material 155, which are to be picked up by the robotic arm 103 and deposited on the conveyor 909 for further movement onto the track material handling system 100. In some aspects, the one or more containment beds 913 may include, without limitation, one bed, two beds, three beds, four beds, or any number of beds. For example, as illustrated in FIG. 6, the number of containment beds 913 is two. The conveyor 909 and the path 931 may be formed between the two containment beds 913.

The robotic arm 103 has a plurality of degrees of freedom and has a retaining mechanism 131 at an end of the robotic arm 103, as disclosed further above (e.g., as illustrated in FIGS. 3A, 3B, and 4). In some aspects, the robotic arm 103 may include, without limitation, at least three moveable joints. The robotic arm 103 is capable of moving along the path 931 and obtaining track material 155 from the one or more containment beds 913. The robotic arm 103 can retain one or more of the plurality of track material 155 and deposit the track material 155 on the conveyor 909. In some aspects, the track material handling system 100 may further include a cart 939 that moves along the path 931 on the vehicle 901. The robotic arm 103 may be disposed in the cart 939. In some aspects, the path 931 may be defined by a track 907. The track 907 may be disposed above the conveyor 909 and the cart 939 may move on the track 907. In some aspects, the controller 201 may receive input from the vision sensor 208 and provide an output in the form of a trigger for movement of the robotic arm 103 to obtain a track material 155. The controller 201 may be configured to cause the cart 939 to move along the path 931, where the cart 939 may move adjacent to the containment beds 913.

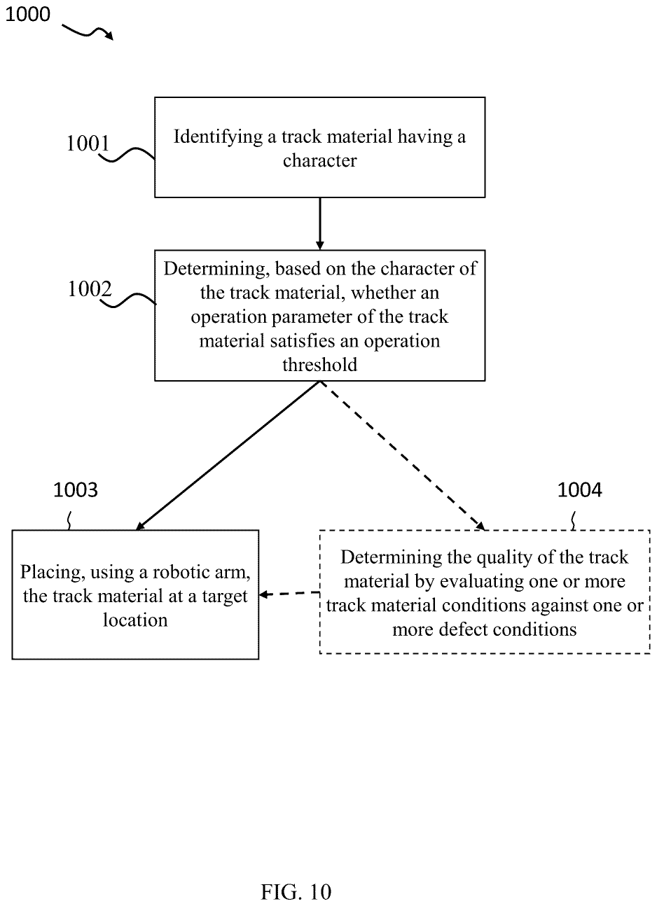

Referring to FIG. 10, a flow diagram of illustrative steps for track material handling is illustrated. The operations of FIG. 10 may be performed by a track material handling system 100, such as a controller 201 of a track material handling system 100. At block 1001, the method 1000 for track material handling includes identifying, using the vision sensor 208, the track material 155 having a character. At block 1002, the method 1000 includes determining, using a trained neural network 209, whether the character of the track material 155, for a rail assembly operation, satisfies an operation threshold. At block 1003, the method 1000 may include, in response to determining whether the character satisfies the operation threshold, placing, using the robotic arm 103, the track material 155. For example, the track material handling system 100 may place the track material 155 at the target location 115.

In some aspects, the method 1000 may further include lifting, before identifying the character of the track material 155 and using the robotic arm 103, the track material 155. The track material may be in an assembled position, a distributed position, or a reinstallation position. The assembled position is a position in which the track material 155 is installed for use within a rail system. The distributed position is a position in which the track material 155 is placed before installation along a track bed. The reinstallation position is a position in which the track material 155 is relocated from the assembled position along a track bed. The track material 155 may be lifted from a plurality of track materials in a bin, in a pile, or on a conveyor. In some aspects, the method 1000 may include lifting, after identifying the character of the track material 155 and using the robotic arm 103, the track material 155.

In some aspects, the target location may be at or proximate to an adjacent node. The adjacent node may include, without limitation, one or more of a rail, a tie, a container associated with the robotic arm or a vehicle, a conveyor, or a rejection place. The target location is at one or more of a job site, a rail side area, or a factory. In some aspects, the target location 115 may include, without limitation, one or more of the rail, the tie, the container associated with the robotic arm or the vehicle, or the conveyor, in response to determining that the character satisfies the operation threshold. In some aspects, the target location 115 may include one or more of the rejection place including, without limitation, one or more of a discard container, a discard chute, a discard pallet, or a discard conveyor, in response to determining that the character fails to satisfy the operation threshold.

In some aspects, the track material 155 may include, without limitation, a tie plate, a spike, an anchor, a clip, a screw, a crosstie, a pad, or a combination thereof. The rail assembly operation may include, without limitation, installation, replacement, distribution, removal, bundling, sliding, loading, or a combination thereof, related to a track. The character of the track material 155 may include, without limitation, a size, a shape, a weight, a hole pattern, a model, an assembly arrangement, a quality, or a combination thereof.

In some aspects, at block 1004, the method 1000 may further include determining the quality of the track material 155 by evaluating one or more track material conditions against one or more defect conditions. The one or more defect conditions may include, without limitation, a deformation, a corrosion, a deviation from an original manufacturing condition, a decay, a structural damage, or a combination thereof.

In some aspects, the neural network 209 may be trained based on a training set of, without limitation, image data, one or more sample rail assembly operations, sample characters of one or more sample track materials, or the like. The method 1000 may further include training the neural network 209 based on at least one of the sample characters or whether the sample characters satisfy corresponding operation thresholds. In some examples, the operation threshold may be a predefined standard for character, helping the neural network 209 learn and predict when the track materials have a sufficient quality (or other character) to be used for a given purpose. The threshold value of the operation threshold may be determined based on, without limitation, quality standards (e.g., minimum and desired level of deformation or crack), performance standards (e.g., force exerted during installation or desired precision in aligning), and/or safety standards (e.g., within safe ranges to prevent damage to components or hazards to operations). The operation threshold may be manually input or generated through the usage of the track material handling system 100. The neural network 209 may be trained to update the threshold value based on continuously collected track material manipulation data.

In some aspects, the method 1000 may further include utilizing the track material 155 in assembling a railroad track. For example, the utilizing may include driving a spike into a tie. The placing may include placing the track material 155 on a conveyor 909. The placing may include orienting the track material 155 in an operation direction. In some aspects, the vision sensor 208 may include, without limitation, one or more of a camera, a proximity sensor, a LiDAR sensor, a thermal image sensor, an infrared sensor, or an ultrasonic sensor.

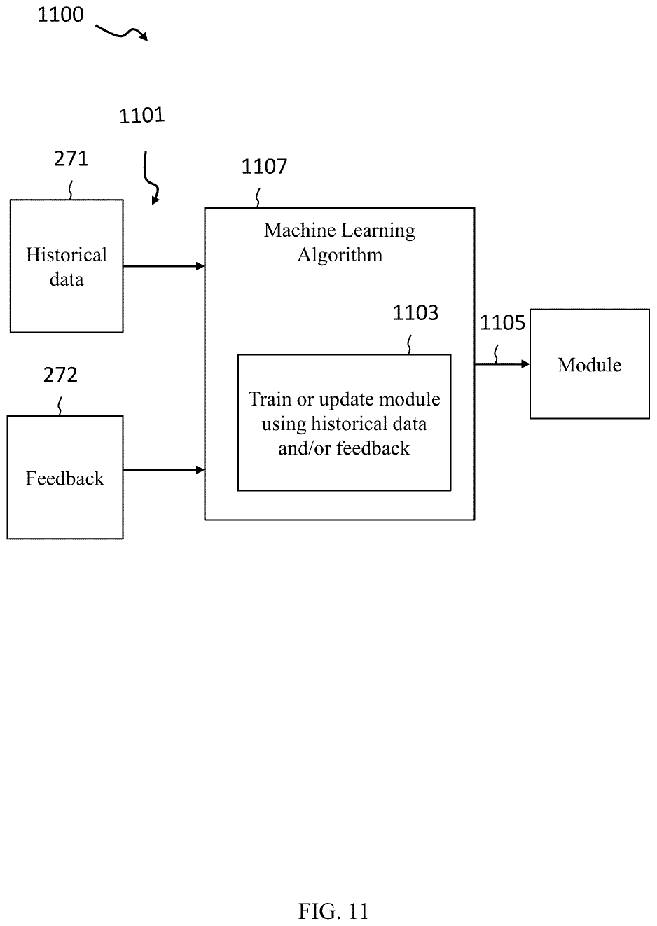

Referring to FIG. 11, a flow diagram of illustrative steps for module training the neural network 209 of the track material handling system 100 is illustrated. In some aspects, the neural network 209 may be pre-trained and/or continuously trained. At block 1101, the method 1100 of neural network training for the track material handling system 100 may include feeding historical data 271 and feedback 272 to a machine learning algorithm 1107 to train the neural network 209. At block 1103, the method 1100 may include training and/or updating one or more modules of the neural network 209 using the historical data 271 and/or feedback 272. At block 1105, the method 1100 may include outputting parameters for the neural network 209. The neural network 209 may be trained, using the machine learning algorithm 1107, with datasets with ground truth data, images related to the handling and/or operation of the track material 155, for example, one or more sample rail assembly operations, sample characters of one or more sample track materials, sample operation parameters associated with the sample rail assembly operations and the sample characters, and an indication (e.g., label) of whether a given sample character or image data satisfies an operation threshold. The machine learning algorithm 1107 may refine the neural network 209 for character determination in view of operation thresholds, track material recognition, or track material manipulation through validation processes, such as backpropagation. The track material handling system 100 (e.g., controller 201) may further apply post-processing to refine the character determination, the track material recognition, and/or the track material manipulation by the neural network 209. For example, the pre-training may include labeling the example images and desirably refining the character determination, the track material recognition, and/or the track material manipulation in the images. The neural network 209 may be continuously trained using the real-world collected data to adapt to changing conditions and factors and improve performance over time.

In some aspects, the machine learning algorithm 1107 may train the neural networks 209 by applying activation functions to training data sets (such as vision sensor data about tracks, vehicles, robotic arms, and other railroad maintenance devices and equipment associated with various maintenance tasks) to determine a solution from adjustable weights and biases applied to nodes within the hidden activation layers to generate one or more outputs as the solution with a minimized error. In machine learning applications, new inputs may be provided (such as the generated one or more outputs) to the neural network model as training data (such as the vision sensor data about tracks, vehicles, robotic arms, and other railroad maintenance devices and equipment associated with various maintenance tasks) to continue to improve accuracy and minimize error of the neural network model. The one or more neural network models may utilize one-to-one, one-to-many, many-to-one, and/or many-to-many (e.g., sequence to sequence) sequence modeling. The one or more neural network models may employ a combination of artificial intelligence techniques, such as, but not limited to, Deep Learning, Random Forest Classifiers, Feature extraction from audio, images, clustering algorithms, or combinations thereof. In some aspects, a CNN may be utilized. For example, the neural network is a class of deep, feed-forward neural networks applied for video and images collected by the vision sensor 208. CNNs may be shift or space invariant and utilize shared-weight architecture and translation.

In some aspects, the machine learning algorithm 1107 may train the neural network 209 based on backpropagation using activation functions. For example, the encoder may generate encoded input data h=(Wx+b) that is transformed from the input data of one or more input channels. The encoded input data of one of the input channels may be represented as hᵢⱼ=g(W xᵢⱼ+b) from the raw input data xᵢⱼ, which is then used to reconstruct the output xᵢⱼ=ƒ(W^{T}hᵢⱼ+b′) . The neural network 209 may reconstruct outputs, such as refining the operation parameter determination, the track material recognition, and/or the track material manipulation, into x′=(W^{T}h+b′), where W is weight, b is bias, and W^{T} and b′ are transverse values of W and b and are learned through backpropagation. In the operation, the neural network 209 may calculate, for each input data, the distance between an input data x and a reconstructed input data x′, to yield a distance vector |x−x′|. The machine learning algorithm 1107 may minimize the loss function for the neural network 209. A loss function is a utility function as the sum of all distance vectors. The accuracy of the predicted output may be evaluated by satisfying a preset value, such as a preset accuracy and area under the curve (AUC) value computed using an output score from the activation function (e.g., the Softmax function or the Sigmoid function). For example, the track material handling system 100 may assign the preset value of the AUC with a value of 0.7 to 0.8 as an acceptable simulation, 0.8 to 0.9 as an excellent simulation, or more than 0.9 as an outstanding simulation. After the training satisfies the preset value, the trained or updated modules may be stored in the controller 201 as the neural network 209.

It will be apparent to those skilled in the art that various modifications and variations can be made to the aspects described herein without departing from the scope of the claimed subject matter. Thus, it is intended that the specification cover the modifications and variations of the various aspects described herein provided such modifications and variations come within the scope of the appended claims and their equivalents.

### EXAMPLE CLAUSES

Clause 1. A method of handling track materials comprising: identifying, using a vision sensor, a track material having a character; determining, using a trained neural network, whether the character of the track material, for a rail assembly operation, satisfies an operation threshold; and in response to determining whether the character satisfies the operation threshold: placing, using a robotic arm, the track material at a target location.

Clause 2. The method of Clause 1, wherein the method further comprises lifting, before identifying the character of the track material and using the robotic arm, the track material.

Clause 3. The method of Clause 2, wherein the track material is in an assembled position, a distributed position, or a reinstallation position.

Clause 4. The method of Clause 3, wherein the assembled position is a position in which the track material is installed for use within a rail system.

Clause 5. The method of Clause 3, wherein the distributed position is a position in which the track material is placed before installation along a track bed.

Clause 6. The method of Clause 3, wherein the reinstallation position is a position in which the track material is relocated from the assembled position along a track bed.

Clause 7. The method of Clause 2, wherein the track material is lifted from a plurality of track materials in a bin, in a pile, or on a conveyor.

Clause 8. The method of any one of preceding Clause(s) 1-7, wherein the method further comprises lifting, after identifying the character of the track material and using the robotic arm, the track material.

Clause 9. The method of any one of preceding Clause(s) 1-8, wherein the target location is at an adjacent node, the adjacent node comprising one or more of: a rail,
a tie, a container associated with the robotic arm or a vehicle, a conveyor, or a rejection place.

Clause 10. The method of Clause 9, wherein, in response to determining that the character satisfies the operation threshold, the target location comprises one or more of the rail, the tie, the container associated with the robotic arm or the vehicle, or the conveyor.

Clause 11. The method of Clause 9, wherein, in response to determining that the character fails to satisfy the operation threshold, the target location comprises one or more of the rejection place comprising one or more of: a discard container; a discard chute; a discard pallet; or a discard conveyor.

Clause 12. The method of Clause 9, wherein the target location is at one or more of a job site, a rail side area, or a factory.

Clause 13. The method of any one of preceding Clause(s) 1-12, wherein the track material comprises a tie plate, a spike, an anchor, a clip, a screw, a crosstie, a pad, a bolt, a nut, a joint, a switch, a rail, or a combination thereof.

Clause 14. The method of any one of preceding Clause(s) 1-13, wherein the rail assembly operation comprises installation, replacement, distribution, removal, bundling, sliding, loading, or a combination thereof, related to a track.

Clause 15. The method of any one of preceding Clause(s) 1-14, wherein the character of the track material comprises: a size, a shape, a weight, a hole pattern, a model, an assembly arrangement, a quality, or a combination thereof.

Clause 16. The method of Clause 15, further comprising determining the quality of the track material by evaluating one or more track material conditions against one or more defect conditions, the one or more defect conditions comprising: a deformation, a corrosion, a deviation from an original manufacturing condition, a decay, a structural damage, or a combination thereof.

Clause 17. The method of any one of preceding Clause(s) 1-16, wherein the neural network is trained based on a training set of: one or more sample rail assembly operations, sample characters of one or more sample track materials, and operation parameters associated with the sample rail assembly operations and the sample characters.

Clause 18. The method of any one of preceding Clause(s) 1-17, further comprising training the neural network based on at least one of the character or whether the character satisfies the operation threshold.

Clause 19. The method of any one of preceding Clause(s) 1-18, wherein the method further comprises utilizing the track material in assembling a railroad track.

Clause 20. The method of Clause 19, wherein the utilizing comprises driving a spike into a tie.

Clause 21. The method of any one of preceding Clause(s) 1-20, wherein the placing comprises placing the track material on a conveyor.

Clause 22. The method of any one of preceding Clause(s) 1-21, wherein the placing comprises orienting the track material in an operation direction.

Clause 23. The method of any one of preceding Clause(s) 1-22, wherein the vision sensor comprises one or more of: a camera, a proximity sensor, a light detection and ranging (LiDAR) sensor, a thermal image sensor, an infrared sensor, or an ultrasonic sensor.

Clause 24. A system for handling track materials comprising: a robotic arm operable to manipulate a track material at a location; a vision sensor associated with the robotic arm; and a controller comprising a trained neural network, wherein: the vision sensor is configured to: identify a character of the track material, and wherein the trained neural network is configured to: determine whether the character of the track material, for a rail assembly operation, satisfies an operation threshold, and wherein the robotic arm is configured to: place the track material at a target location.

Clause 25. The system of Clause 24, wherein the robotic arm is mechanically coupled to a vehicle configured to move along a path comprising a rail.

Clause 26. The system of any one of preceding Clause(s) 24-25, wherein the controller is configured to cause the robotic arm to lift the track material.

Clause 27. The system of Clause 26, wherein the track material is in an assembled position, a distributed position, or a reinstallation position.

Clause 28. The system of Clause 27, wherein the assembled position is a position in which the track material is installed for use within a rail system.

Clause 29. The system of Clause 27, wherein the distributed position is a position in which the track material is placed before installation along a track bed.

Clause 30. The system of Clause 27, wherein the reinstallation position is a position in which the track material is relocated from the assembled position along a track bed.

Clause 31. The system of Clause 26, wherein the controller is configured to cause the robotic arm to lift the track material from a plurality of track materials in a bin, in a pile, or on a conveyor.

Clause 32. The system of any one of preceding Clause(s) 24-31, wherein the target location comprises one or more of: a rail, a tie, a container associated with the robotic arm or a vehicle, a conveyor, or a rejection place.

Clause 33. The system of Clause 32, wherein the target location is at one or more of a job site, a rail side area, or a factory.

Clause 34. The system of any one of preceding Clause(s) 24-33, wherein the controller is configured to, in response to determining that the character satisfies the operation threshold, cause the robotic arm to place the track material at the target location, wherein the target location is at or proximate to an adjacent node, the adjacent node comprising one or more of: a rail, a tie, a container associated with the robotic arm or a vehicle, or a conveyor.

Clause 35. The system of any one of preceding Clause(s) 24-34, wherein the controller is configured to, in response to determining that the character fails to satisfy the operation threshold, cause the robotic arm to place the track material at the target location comprising a rejection place, the rejection place comprising: a discard container; a discard chute; a discard pallet; or a discard conveyor.

Clause 36. The system of any one of preceding Clause(s) 24-35, wherein the track material comprises a tie plate, a spike, an anchor, a clip, a screw, a crosstie, a pad, a bolt, a nut, a joint, a switch, a rail, or a combination thereof.

Clause 37. The system of any one of preceding Clause(s) 24-36, wherein the rail assembly operation comprises installation, replacement, distribution, removal, bundling, sliding, loading, or a combination thereof, related to a track.

Clause 38. The system of any one of preceding Clause(s) 24-37, wherein the character of the track material comprises: a size, a shape, a weight, a hole pattern, a model, an assembly arrangement, a quality, or a combination thereof.

Clause 39. The system of Clause 38, wherein the controller is configured to determine, using the trained neural network, the quality of the track material by evaluating one or more track material conditions against one or more defect conditions, the one or more defect conditions comprising: a deformation, a corrosion, a deviation from an original manufacturing condition, a decay, a structural damage, or a combination thereof.

Clause 40. The system of any one of preceding Clause(s) 24-39, wherein the neural network is trained based on a training set of: one or more sample rail assembly operations; sample characters of one or more sample track materials; and information indicating whether the sample characters satisfy respective operation thresholds.

Clause 41. The system of any one of preceding Clause(s) 24-40, wherein the controller is configured to train the neural network based on at least one of the character or whether the character satisfies the operation threshold.

Clause 42. The system of any one of preceding Clause(s) 24-41, wherein the controller is configured to cause the robotic arm to utilize the track material in assembling a railroad track.

Clause 43. The system of Clause 42, wherein the track material comprises a spike and, to utilize the track material, the controller is configured to cause the robotic arm to drive the spike into a tie.

Clause 44. The system of any one of preceding Clause(s) 24-43, wherein the robotic arm is configured to place the track material on a conveyor.

Clause 45. The system of any one of preceding Clause(s) 24-44, wherein the robotic arm is configured to orient the track material in an operation direction.

Clause 46. The system of any one of preceding Clause(s) 24-45, wherein the vision sensor comprises one or more of: a camera, a proximity sensor, a light detection and ranging (LiDAR) sensor, a thermal image sensor, an infrared sensor, or an ultrasonic sensor.

1. A method of handling track materials comprising:
identifying, using a vision sensor, a track material having a character;
determining, using a trained neural network, whether the character of the track material, for a rail assembly operation, satisfies an operation threshold; and
in response to determining whether the character satisfies the operation threshold:
placing, using a robotic arm, the track material at a target location.

2. The method of claim 1, wherein the method further comprises lifting, before identifying the character of the track material and using the robotic arm, the track material.

3. The method of claim 2, wherein the track material is in an assembled position, a distributed position, or a reinstallation position.

4. The method of claim 3, wherein the assembled position is a position in which the track material is installed for use within a rail system.

5. The method of claim 3, wherein the distributed position is a position in which the track material is placed before installation along a track bed.

6. The method of claim 3, wherein the reinstallation position is a position in which the track material is relocated from the assembled position along a track bed.

7. The method of claim 2, wherein the track material is lifted from a plurality of track materials from one or more of a bin, a pile, or a conveyor.

8. The method of claim 1, wherein the method further comprises lifting, after identifying the character of the track material and using the robotic arm, the track material.

9. The method of claim 1, wherein the target location is at an adjacent node, the adjacent node comprising one or more of:
a rail,
a tie,
a container associated with the robotic arm or a vehicle,
a conveyor, or
a rejection place.

10. The method of claim 9, wherein, in response to determining that the character satisfies the operation threshold, the target location comprises one or more of the rail, the tie, the container associated with the robotic arm or the vehicle, or the conveyor.

11. The method of claim 9, wherein, in response to determining that the character fails to satisfy the operation threshold, the target location comprises one or more of the rejection place comprising one or more of:
a discard container;
a discard chute;
a discard pallet; or
a discard conveyor.

12. The method of claim 9, wherein the target location is at one or more of a job site, a rail side area, or a factory.

13. The method of claim 1, wherein the track material comprises one or more of a tie plate, a spike, an anchor, a clip, a screw, a crosstie, a pad, a bolt, a nut, a joint, a switch, or a rail.

14. The method of claim 1, wherein the rail assembly operation comprises one or more of an installation, a replacement, a distribution, a removal, a bundling, a sliding, or a loading, related to a track.

15. The method of claim 1, wherein the character of the track material comprises one or more of:
a size,
a shape,
a weight,
a hole pattern,
a model,
an assembly arrangement, or
a quality.

16. The method of claim 15, further comprising determining the quality of the track material by evaluating one or more track material conditions against one or more defect conditions, the one or more defect conditions comprising:
a deformation,
a corrosion,
a deviation from an original manufacturing condition,
a decay, or
a structural damage.

17. The method of claim 1, wherein the trained neural network is trained based on a training set of:
one or more sample rail assembly operations,
sample characters of one or more sample track materials, and
operation parameters associated with the one or more sample rail assembly operations and the sample characters.

18. The method of claim 1, further comprising training the trained neural network based on at least one of the character or whether the character satisfies the operation threshold.

19. A system for handling track materials comprising:
a robotic arm operable to manipulate a track material at a location;
a vision sensor associated with the robotic arm; and
a controller comprising a trained neural network;
wherein:
the vision sensor is configured to identify a character of the track material;
the trained neural network is configured to determine whether the character of the track material, for a rail assembly operation, satisfies an operation threshold; and
the robotic arm is configured to place the track material at a target location.

20. A processing system comprising one or more processors and one or more memories coupled with the one or more processors and configured to cause the processing system to:
identify, using a vision sensor associated with a robotic arm, a character of track material, wherein the robotic arm is configured to manipulate a track material at a target location;
determine, using a trained neural network, that a character of the track material satisfies an operation threshold of a rail assembly operation; and
in response to determining that the character of the track material satisfies the operation threshold of the rail assembly operation:
place, using the robotic arm, the track material at the target location.
